(19) United States
(12) Patent Application Publication
(10) Pub. No.: US 2015/0287970 A1
(43) Pub. Date: Oct. 8, 2015

(54) CELL AND ASSEMBLED BATTERY

(71) Applicant: HITACHI VEHICLE ENERGY, LTD., Hitachinaka-shi, Ibaraki (JP)

(72) Inventor: Hideki Shinohara, Hitachinaka-shi (JP)

(73) Assignee: Hitachi Automotive Systems, Ltd., Hitachinaka-shi, Ibaraki (JP)

(21) Appl. No.: 14/437,369

(22) PCT Filed: Nov. 16, 2012
(86) PCT No.: PCT/JP2012/079804

§ 371 Date: Apr. 21, 2015

(51) Int. Cl. H01M 2/20; H01M 2/10; H01M 2/30

(52) U.S. Cl. CPC H01M 2/206; H01M 2/305; H01M 2/1072; H01M 2220/20

(57) ABSTRACT

A cell includes: a connection member that is formed by combining a first metal material and a second metal material and that includes an interface between the first metal material and the second metal material formed in a current path of charge/discharge current; and a sacrificial anticorrosion layer that is provided to the connection member and arranged to be in contact with at least one of the first metal material and the second metal material. The first metal material is a pure aluminum or an aluminum alloy. The second metal material is a pure copper or a copper alloy. The sacrificial anticorrosion layer is formed of a material having an ionization tendency greater than that of the first metal material.

### TECHNICAL FIELD

The present invention relates to a cell and an assembled battery including multiple cells.

### BACKGROUND ART

In recent years, development is being advanced for a secondary battery having a large battery capacity (Wh) as a power source for hybrid electric vehicles and electric vehicles that use electric power alone. In particular, prismatic lithium-ion batteries having a high energy density (Wh/kg) have been attracting attention.

In such a prismatic lithium-ion secondary battery, a wound electrode group having a flat shape is formed by winding a positive electrode foil coated with a positive-electrode active material, a negative electrode foil coated with a negative-electrode active material, and a separator configured to provide electrical insulation between the positive electrode foil and the negative electrode foil after they are stacked. The wound electrode group is electrically connected to a positive electrode external terminal and a negative electrode external terminal provided to a battery cover. The wound electrode group is housed in a battery casing. The opening of the battery casing is sealed with the battery cover by welding. After an electrolyte solution is poured via an injection opening of the battery casing housing the wound electrode group, the injection opening is sealed by laser welding after an injection plug is inserted into the injection opening so as to form a secondary cell.

The multiple prismatic lithium-ion secondary cells (cells) are arranged such that their positive electrode external terminals and negative electrode external terminals are electrically connected, using electro-conductive members such as bus bars or the like, so as to form an assembled battery. By electrically connecting the external terminals to an external device using an electro-conductive member such as a lead line or the like, electric power can be supplied to the external device and on the other hand, the secondary battery can be charged using externally generated electric power.

For electrochemical reasons, the positive electrode external terminal is formed of a pure aluminum or an aluminum alloy, and the negative electrode external terminal is formed of a pure copper or a copper alloy. Accordingly, in a case in which the positive electrode external terminal of a given cell is electrically connected to the negative electrode external terminal of a different cell, a dissimilar metal interface is formed in the charge/discharge current path.

If such a dissimilar metal interface comes into contact with an external corrosive material, an electrochemical local battery may be formed, leading to corrosion in a pure aluminum or an aluminum alloy having an ionization tendency that is greater than that of a pure copper or a copper alloy, which is a so-called galvanic corrosion phenomenon. This may result in disconnection of a member formed of a pure aluminum or an aluminum alloy.

Patent Literature 1 discloses a secondary battery having a structure in which an anti-corrosion member formed of a nickel, a stainless steel, or the like, with an ionization tendency ranging between those of copper and aluminum, is provided between a terminal formed of a copper and a fixing member formed of an aluminum, so as to suppress the occurrence of the galvanic corrosion phenomenon.

### CITATION LIST

### Patent Literature

PTL 1: Japanese Laid Open Patent Publication No. 2011-77039

### SUMMARY OF INVENTION

### Technical Problem

With the secondary battery described in Patent Literature 1, an electrochemical potential difference is generated between a nickel and an aluminum and galvanic corrosion occurs in the aluminum so that the volume of the aluminum member is reduced. Due to the increase in, the contact resistance at an interface between the nickel member and the aluminum member, output of the secondary battery may be deteriorated.

### Solution to Problem

A cell according to a first aspect of the present invention comprises: a connection member that is formed by combining a first metal material and a second metal material and that includes an interface between the first metal material and the second metal material formed in a current path of charge/discharge current; and a sacrificial anticorrosion layer that is provided to the connection member and arranged to be in contact with at least one of the first metal material and the second metal material, wherein: the first metal material is a pure aluminum or an aluminum alloy; the second metal material is a pure copper or a copper alloy; and the sacrificial anticorrosion layer is formed of a material having an ionization tendency greater than that of the first metal material.

An assembled battery according to a second aspect of the present invention comprises a plurality of cells which are electrically connected with each other, the assembled battery, and further comprises: a connection member that is formed by coupling a first metal material and a second metal material and that includes an interface between the first metal material and the second metal material; and a sacrificial anticorrosion layer that is provided to the connection member arranged to be in contact with at least one of the first metal material and the second metal material, wherein: the first metal material is a pure aluminum or an aluminum alloy; the second metal material is a pure copper or a copper alloy; and the sacrificial anticorrosion layer is formed of a material having an ionization tendency greater than that of the first metal material.

### Advantageous Effects of Invention

With the present invention, an increase in contact resistance due to corrosion at an interface between a pure aluminum or an aluminum alloy and a pure copper or a copper alloy can be suppressed, thereby suppressing a reduction in the output of a battery over a long period of time.

### BRIEF DESCRIPTION OF DRAWINGS

FIG. 1 is a plan view of an assembled battery according to a first embodiment.

FIG. 2 is a perspective view showing an external structure of a cell that is a component of the assembled battery shown in FIG. 1.

FIG. 3 is an exploded perspective view showing a configuration of the cell shown in FIG. 2.

FIG. 4 is a perspective view showing a wound electrode group shown in FIG. 3.

FIG. 5(a) is a diagram showing a sacrificial anticorrosion member provided to a bus bar of an assembled battery according to the first embodiment, FIG. 5(b) is an enlarged view of a portion C shown in FIG. 5(a), and FIG. 5(c) is a diagram showing a bus bar having a structure that differs from that of the bus bar shown in FIG. 5(b).

FIG. 6(a) is a diagram showing analysis results of the corrosion current density on a corrosion surface of the bus bar shown in FIG. 5, and FIG. 6(b) is a diagram showing an analysis model of the bus bar shown in FIG. 5.

FIG. 7(a) is a diagram showing analysis results of the corrosion current density on a corrosion surface of a bus bar having no sacrificial anticorrosion member, and FIG. 7(b) is a diagram showing an analysis model of the bus bar having no sacrificial anticorrosion member.

FIG. 8(a) is a diagram showing analysis results of the corrosion current density on a corrosion surface of a bus bar having a nickel arranged between an aluminum and a copper, and FIG. 8(b) is a diagram showing an analysis model of the bus bar having such a nickel between the aluminum and the copper.

FIG. 9 is a diagram showing a sacrificial anticorrosion member provided to a bus bar of an assembled battery according to a modification (1) of the first embodiment.

FIG. 10(a) is a diagram showing analysis results of the corrosion current density on a corrosion surface of the bus bar shown in FIG. 9, and FIG. 10(b) is a diagram showing an analysis model of the bus bar shown in FIG. 9.

FIG. 11 is a diagram showing the relation between an aluminum/copper interface and the distance X to a sacrificial anticorrosion member.

FIG. 12 is a graph showing the relation between the distance X and the corrosion current.

FIG. 13 is a diagram showing a sacrificial anticorrosion member provided to a bus bar of an assembled battery according to a modification (2) of the first embodiment.

FIG. 14(a) is a diagram showing analysis results of the corrosion current density on a corrosion surface of the bus bar shown in FIG. 13, and FIG. 14(b) is a diagram showing an analysis model of the bus bar shown in FIG. 13.

FIG. 15 is a diagram showing a sacrificial anticorrosion member provided to a bus bar of an assembled battery according to a modification (3) of the first embodiment.

FIG. 16(a) is a diagram showing analysis results of the corrosion current density on a corrosion surface of the bus bar shown in FIG. 15, and FIG. 16(b) is a diagram showing an analysis model of the bus bar shown in FIG. 15.

FIG. 17 is a diagram showing a sacrificial anticorrosion member provided to a positive electrode external terminal of a cell that is a component of an assembled battery according to a second embodiment.

FIG. 18 is a diagram showing a sacrificial anticorrosion member provided to a negative electrode external terminal of a cell that is a component of a assembled battery according to a modification of the second embodiment.

FIG. 19 is a diagram showing a sacrificial anticorrosion member arranged to be in contact with both a bus bar of an assembled battery and a positive electrode external terminal of a cell according to a third embodiment.

FIG. 20 is a diagram showing a sacrificial anticorrosion member arranged to be in contact with a bus bar of an assembled battery and a negative electrode external terminal of a cell according to a modification of the third embodiment.

FIG. 21 is a diagram showing a sacrificial anticorrosion member arranged to be in contact with both a bus bar of an assembled battery and a positive electrode external terminal of a cell according to a fourth embodiment.

FIG. 22 is a diagram showing a sacrificial anticorrosion member arranged to be in contact with both a bus bar of an assembled battery and a negative electrode external terminal of a cell according to a modification of the fourth embodiment.

FIG. 23 is a diagram showing a sacrificial anticorrosion member provided to a positive electrode external terminal of a cell that is a component of an assembled battery according to a fifth embodiment.

FIG. 24 is a diagram showing a sacrificial anticorrosion member provided to a negative electrode external terminal of a cell that is a component of an assembled battery according to a modification of the fifth embodiment.

FIG. 25 is a diagram showing a laminated electrode group configured by laminating rectangular positive electrodes and rectangular negative electrodes.

### DESCRIPTION OF EMBODIMENTS

Description will be made below with reference to the drawings regarding embodiments applied to an assembled battery including multiple prismatic lithium-ion secondary cells (which will be referred to as “cells” hereafter), which is to be fit in an electric storage device mounted on a hybrid electric vehicle or an electric vehicle that uses electric power alone.

### First Embodiment

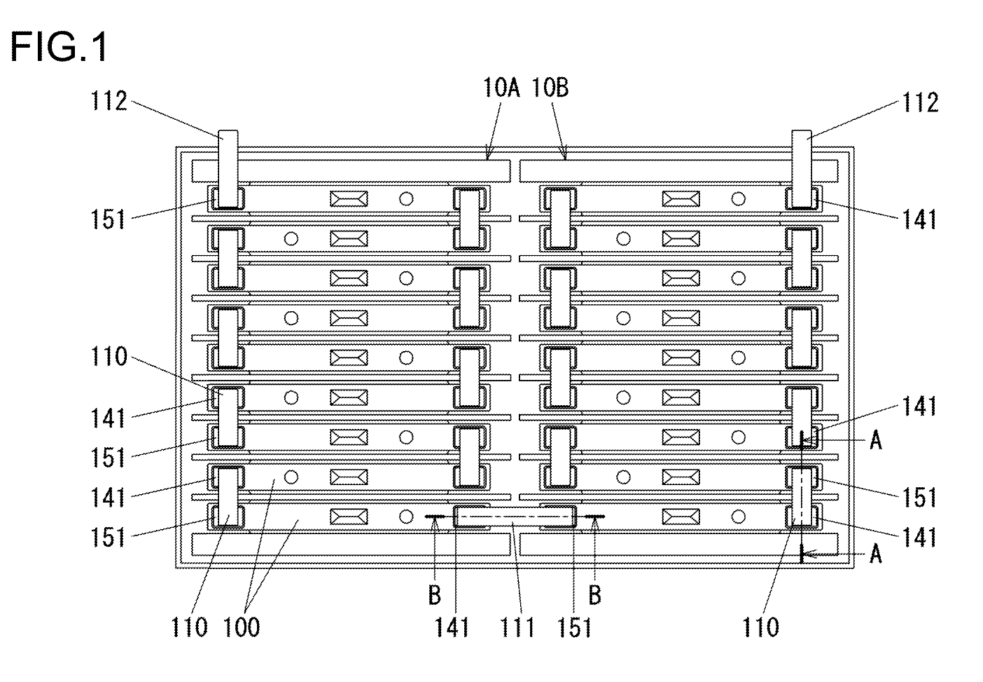

FIG. 1 is a plan view showing an assembled battery according to a first embodiment of the present invention. As shown in FIG. 1, the assembled battery includes two cell groups arranged adjacent to each other, i.e., a first cell group 10A having nine cells 100 connected in series and a second cell group 10B having nine cells 100 connected in series.

The cells 100, each of which is a flat, rectangular parallelepiped component of the first cell group 10A, are arranged such that the wide side face, i.e., the side face having a wider area, of each cell faces the wide side face of the adjacent cell. In the same way, the cells 100, each of which is a flat, rectangular parallelepiped component of the second cell group 10B, are arranged such that the wide side face, i.e., the side face having a wider area, of each cell faces the wide side face of the adjacent cell.

The cells 100 that form the first cell group 10A are arranged such that the orientation of each cell 100 is the reverse of that of the adjacent cell 100, i.e., such that the position relation between a positive electrode external terminal 141 and a negative electrode external terminal 151 of each cell 100 is the reverse of that of the adjacent cell 100. The positive electrode external terminal 141 of each cell 100 is electrically connected to the negative electrode external terminal 151 of the adjacent cell 100 by means of a bus bar 110 that is an electro-conductive member shaped as a flat rectangular plate. In the same way, the cells 100 that form the second cell group 10B are arranged such that the orientation of each cell 100 is the reverse of that of the adjacent cell 100, i.e., such that the position relation between a positive electrode external terminal 141 and a negative electrode external terminal 151 of each cell 100 is the reverse of that of the adjacent cell 100. The positive electrode external terminal 141 of each cell 100 is electrically connected to the negative electrode external terminal 151 of the adjacent cell 100 by means of a bus bar 110 that is an electro-conductive member shaped as a flat rectangular plate.

The bus bars 110 and a bus bar 111 are each connected to the corresponding positive electrode external terminal 141 and negative electrode external terminal 151 by laser welding.

The assembled battery formed of the first cell group 10A and the second cell group 10B shown in FIG. 1 is connected in series or in parallel with a different assembled battery by means of a bus bar 112. Otherwise, the assembled battery is connected to an unshown electric power output terminal by means of the bus bar 112. In this case, the assembled battery is electrically connected to an external device via a lead line connected to the electric power output terminal.

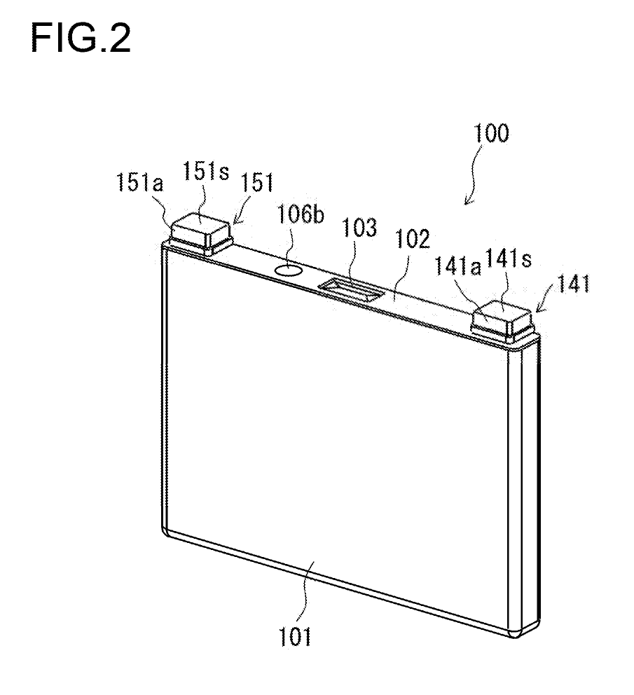

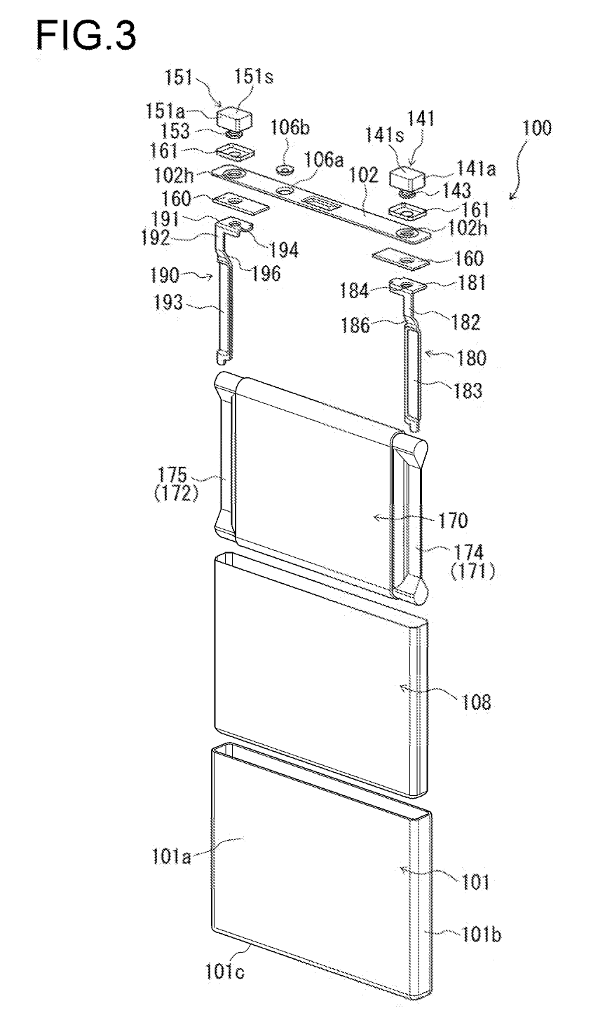

Description will be made regarding the cell 100 that is a component of the assembled battery. The cells 100 that form the assembled battery each have the same configuration. FIG. 2 is a perspective view showing an external structure of the cell 100. FIG. 3 is an exploded perspective view of the configuration of the cell 100.

As shown in FIGS. 2 and 3, each cell 100 includes a battery container, shaped as a flat rectangular parallelepiped, comprising a battery casing 101 and a battery cover 102. The battery casing 101 and the battery cover 102 are formed of an aluminum material or the like.

As shown in FIG. 3, the battery casing 101 houses a wound electrode group 170. Each battery casing 101 is configured to have a box-shaped structure having a bottom and an opening on its one side, and having a pair of wide side faces 101a, a pair of narrow side faces 101b, and a bottom face 101c. The wound electrode group 170 covered by an insulator casing 108 is housed in the battery casing 101. The insulator casing 108 is formed of a resin material such as polypropylene, polyethylene terephthalate, or the like, having a property of electrical insulation. This provides electrical insulation between the wound electrode group 170 and the bottom face and side faces of the battery casing 101.

As shown in FIGS. 2 and 3, the battery cover 102 has a flat, rectangular shape, and is fixed by welding so as to cover the opening of the battery casing 101. That is to say the opening of the battery casing 101 is sealed by the battery cover 102. The battery cover 102 is provided with the positive electrode external terminal 141 and the negative electrode external terminal 151.

The positive electrode external terminal 141 is electrically connected to a positive electrode 174 of the wound electrode group 170 via a positive electrode collector body 180. The negative electrode external terminal 151 is electrically connected to a negative electrode 175 of the wound electrode set 170 via a negative electrode collector body 190. This allows electric power to be supplied to an external load via the positive electrode external terminal 141 and the negative electrode external terminal 151. Also, this allows externally generated electric power to be supplied to the wound electrode group 170 via the positive electrode external terminal 141 and the negative electrode external terminal 151, thereby charging the cell 100.

As shown in FIG. 3, a liquid injection opening 106a, which is used to inject electrolyte into the battery container, is formed in the battery cover 102. The liquid injection opening 106a is sealed by an injection plug 106b after the electrolyte is injected. Examples of such electrolyte that can be employed include a non-aqueous electrolyte obtained by dissolving a lithium salt such as lithium hexafluorophosphate (LiPF₆) or the like in a carbonate ester organic solvent such as ethylene carbonate or the like.

As shown in FIG. 2, a gas release vent 103 is provided as a recess formed in the face of the battery cover 102. The gas release vent 103 is formed by thinning a part of the battery cover 102 by pressing so that the stress concentration effect becomes relatively high when the internal pressure rises. If gas is generated due to heat generation resulting from an abnormal operation of the cell 100 such as overcharging or the like, and if the pressure in the battery container rises and exceeds a predetermined pressure (e.g., approximately 1 MPa), the gas release vent 103 breaks so as to provide an opening. This allows the gas to be discharged from the inner space of the battery container, thereby reducing the pressure in the battery container.

As shown in FIG. 3, the battery cover 102 is provided with the positive electrode external terminal 141, the negative electrode external terminal 151, the positive electrode collector body 180, and the negative electrode collector body 190. A terminal reception unit 161 is arranged between the positive electrode external terminal 141 and the battery cover 102. In the same way, a terminal reception unit 161 is arranged between the negative electrode external terminal 151 and the battery cover 102. Furthermore, a collector body reception unit 160 is arranged between the positive electrode collector body 180 and the battery cover 102. In the same way, a collector body reception unit 160 is arranged between the negative electrode collector body 190 and the battery cover 102.

For electrochemical reasons, the positive electrode external terminal 141, the positive electrode collector body 180, and a positive electrode foil 171 of the wound electrode group 170 described later are each formed of a pure aluminum or an aluminum alloy. The negative electrode external terminal 151, the negative electrode collector body 190, and a negative electrode foil 172 of the wound electrode group 170 described later are each formed of a pure copper or a copper alloy. Such a pure aluminum material is not restricted to an aluminum having a purity of 100% and it may contain impurities inevitably mixed in an ordinary refining process or an ordinary manufacturing process. Such an aluminum alloy material may contain impurities so long as it contains aluminum with the highest content among its components. That is to say, such an aluminum alloy represents an alloy containing aluminum as its major component. Similarly, such a pure copper material is not restricted to a copper material having a purity of 100% and it may contain impurities inevitably mixed in an ordinary refining process or an ordinary manufacturing process. Such a copper alloy material may contain impurities so long as it contains copper with the highest content among its components. That is to say, such a copper alloy represents an alloy containing copper as its major component. Such a pure aluminum material or an aluminum alloy material will be referred to as the “aluminum” hereafter. Also, such a pure copper material or a copper alloy material will be referred to as the “copper” hereafter.

The positive electrode external terminal 141 has a base 141a having a rectangular parallelepiped shape and a protrusion that protrudes from the face of the base 141a on the battery cover 102 side toward the battery cover 102. The face of the base 141a that is opposite to the face on the battery cover 102 side is configured as a flat face 141s to be in contact with a bus bar. The protrusion is arranged such that it passes through a through hole of the terminal reception unit 161, a through hole 102h of the battery cover 102, a through hole of the collector body reception unit 160, and a through hole 184 of a terminal connection plate 181 of the positive electrode collector body 180. Subsequently, the tip of the protrusion is fixed by swaging to the terminal connection plate 181 of the positive electrode collector body 180 in the battery container, thereby forming a swage portion 143. After the swage portion 143 is fixed to the terminal connection plate 181 by swaging, these members are further fixed by laser spot welding. This allows the positive electrode external terminal 141 to be electrically connected to the positive electrode collector body 180 and also both the positive electrode external terminal 141 and the positive electrode collector body 180 are fixed to the battery cover 102.

The negative electrode external terminal 151 has a base 151a having a rectangular parallelepiped shape and a protrusion that protrudes from the face of the base 151a on the battery cover 102 side toward the battery cover 102. The face of the base 151a that is opposite to the face on the battery cover 102 side is configured as a flat face 151s to be in contact with a bus bar. The protrusion is arranged such that it passes through a through hole of the terminal reception unit 161, a through hole 102h of the battery cover 102, a through hole of the collector body reception unit 160, and a through hole 194 of a terminal connection plate 191 of the negative electrode collector body 190. Subsequently, the tip of the protrusion is fixed by swaging to the terminal connection plate 191 of the negative electrode collector body 190 in the battery container, thereby forming a swage portion 153. After the swage portion 153 is fixed to the terminal connection plate 191 by swaging, these members are further fixed by laser spot welding. This allows the negative electrode external terminal 151 to be electrically connected to the negative electrode collector body 190. Furthermore, both the negative electrode external terminal 151 and the negative electrode collector body 190 are fixed to the battery cover 102.

The terminal reception unit 161 and the collector body reception unit 160 are each formed of resin material such as polybutylene terephthalate, polyphenylenesulfide, perfluoro-alkoxy fluorine resin, or the like, having a property of electrical insulation. The terminal reception units 160 are arranged between the positive electrode external terminal 141 and the battery cover 102 and between the battery cover 102 and the negative electrode external terminal 151, respectively. This provides electrical insulation between the positive electrode external terminal 141 and the battery cover 102 and between the negative electrode external terminal 151 and the battery cover 102. Furthermore, the terminal reception members 160 are arranged between the terminal connection plate 181 of the positive electrode collector body 180 and the battery cover 102 and between the terminal connection plate 191 of the negative electrode collector body 190 and the battery cover 102, respectively. This provides electrical insulation between the positive electrode collector body 180 and the battery cover 102 and between the negative electrode collector body 190 and the battery cover 102.

As shown in FIG. 3, the positive electrode collector body 180 includes: the terminal connection plate 181 having a flat rectangular plate shape, which is to be arranged along the inner face of the battery cover 102; a flat plate portion 182 configured such that it extends in a direction that is approximately orthogonal to a long side of the terminal connection plate 181 and toward the bottom face 101c of the battery casing 101 along the wide side face 101a of the battery casing 101; and a connection plate 183 connected to the flat plate portion 182 via a coupling portion 186 arranged at the lower end of the flat plate portion 182. The connection plate 183 is configured as a portion that is connected to the positive electrode 174 of the wound electrode group 170 by ultrasonic bonding.

Similarly, the negative electrode collector body 190 includes: the terminal connection plate 191 having a flat rectangular plate shape, which is to be arranged along the inner face of the battery cover 102; a flat plate portion 192 configured such that it extends in a direction that is approximately orthogonal to a long side of the terminal connection plate 191 and toward the bottom face 101c of the battery casing 101 along the wide side face 101a of the battery casing 101; and a connection plate 193 connected to the flat plate portion 192 via a coupling portion 196 arranged at the lower end of the flat plate portion 192. The connection plate 193 is configured as a portion that is connected to the negative electrode 175 of the wound electrode group 170 by ultrasonic bonding.

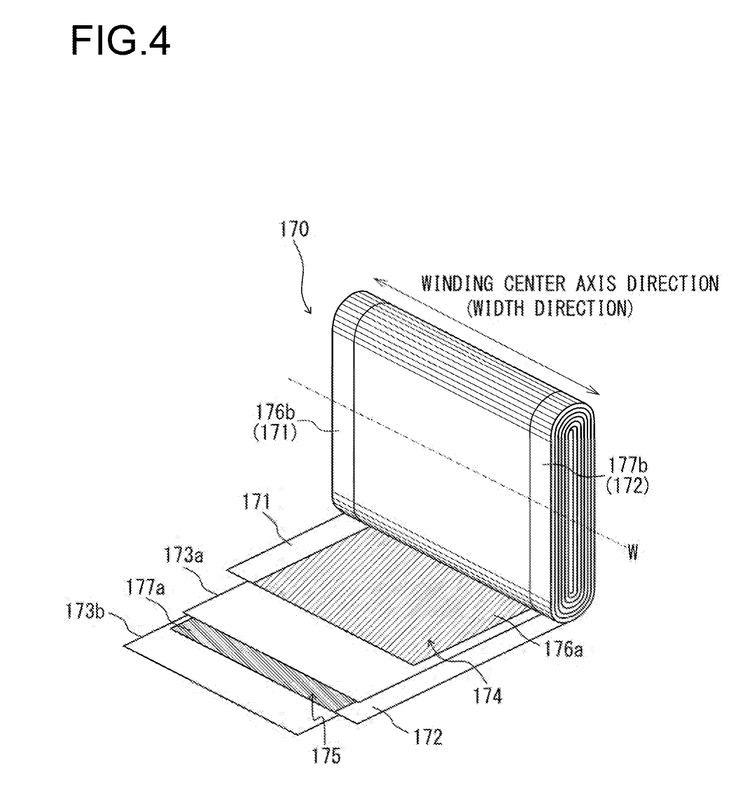

Description will be made with reference to FIG. 4 regarding the wound electrode group 170. FIG. 4 is a perspective view showing the wound electrode group 170 housed in the battery casing 101 of the cell 100, and showing a state in which the winding end side of the wound electrode group 170 is unwound. The wound electrode group 170, which is a electric power generating unit, has a laminated structure having a flat shape obtained by winding the positive electrode 174 and the negative electrode 175 each having a large length around the winding center axis W via separators 173a and 173b.

The positive electrode 174 has a positive electrode coated portion 176a obtained by applying a positive electrode active material mixture to both faces of the positive electrode foil 171 and a positive electrode uncoated portion 176b configured as a portion of the positive electrode foil 171 having no positive electrode active material mixture applied to either face. The positive electrode active material mixture is prepared by adding a binder to a positive electrode active material. The negative electrode 175 has a negative electrode coated portion 177a obtained by applying a negative electrode active material mixture to both faces of the negative electrode foil 172 and a negative electrode uncoated portion 177b configured as a portion of the negative electrode foil 172 having no negative electrode active material mixture applied to either face. The negative electrode active material mixture is prepared by adding a binder to a negative electrode active material. Charging and discharging are performed between the positive electrode active material and the negative electrode active material.

The positive electrode foil 171 is configured as an aluminum foil having a thickness on the order of 20 to 30 μm. The negative electrode foil 172 is configured as a copper foil having a thickness on the order of 15 to 20 μm. The separators 173a and 173b are each configured of a microporous polyethylene resin that is permeable to lithium ions. The positive electrode active material is configured as a lithium-containing transition metal multiple oxide such as lithium manganese oxide or the like. The negative electrode active material is configured as a carbon material such as graphite or the like that is capable of reversibly storing and releasing lithium ions.

The wound electrode group 170 is provided with a laminated portion of the positive electrode uncoated portion 176b (exposed portion of the positive electrode foil 171) on one end of the width direction of the wound electrode group 170 (direction of the winding center axis W that is orthogonal to the winding direction). Furthermore, the wound electrode group 170 is provided with a laminated portion of the negative electrode uncoated portion 177b (exposed portion of the negative electrode foil 172) on the other end of the width direction of the wound electrode group 170. The laminated portion of the positive electrode uncoated portion 176b and the laminated portion of the negative electrode uncoated portion 177b are each flattened, and are then electrically connected by ultrasonic bonding to the connection plate 183 of the positive electrode collector body 180 and the connection plate 193 of the negative electrode collector body 190, respectively.

The wound electrode group 170 is arranged in the battery container such that one curved portion faces the battery cover 102, the other curved portion faces the bottom face 101c, and the flat portions face the respective wide side faces 101a.

As described above, the positive electrode external terminal 141 and the negative electrode external terminal 151 are formed of an aluminum and a copper, respectively. Thus, in a case in which the positive electrode external terminal 141 of a given cell 100 is electrically connected to the negative electrode external terminal 151 of a different cell 100, an aluminum/copper interface is formed in the charge/discharge current path. Since an electrochemical potential difference is generated between the copper and the aluminum, if the bus bar 110 is exposed to a corrosive environment, e.g., if moisture in the ambient air adheres to the surface of the bus bar 110 while no anticorrosion measure is taken, the thickness of the aluminum member is reduced due to galvanic corrosion. In some cases, this leads to an increased contact resistance at the interface, resulting in a problem of reduced output of the battery.

In order to solve such a problem, in the present embodiment, a sacrificial anticorrosion member formed of a material having an ionization tendency that is greater than that of aluminum is arranged in the vicinity of the interface. With such an arrangement, first-stage corrosion occurs in the sacrificial anticorrosion member having a potential lower than that of aluminum, thereby preventing the occurrence of corrosion in the aluminum member. In general, such an effect is referred to as a “sacrificial anticorrosion effect (sacrificial corrosion prevention)”. Detailed description will be made below regarding an arrangement configured to prevent the occurrence of corrosion in the aluminum member using the sacrificial anticorrosion effect.

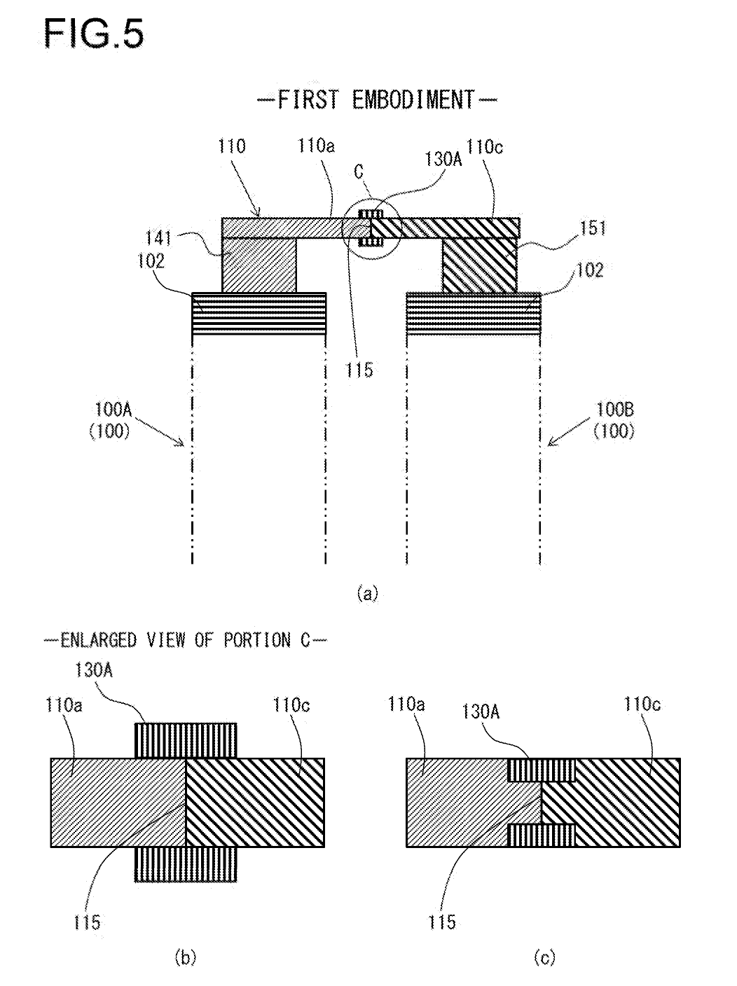

FIG. 5(a) is a diagram showing a sacrificial anticorrosion member 130A provided to the bus bar 110 of the assembled battery according to the first embodiment. Specifically, FIG. 5(a) shows a schematic cross-sectional diagram taken along line A-A in FIG. 1. It should be noted that a similar cross-sectional view is obtained along line B-B in FIG. 1. FIG. 5(b) is an enlarged view of a portion C shown in FIG. 5(a). In each drawing, the thickness of the sacrificial anticorrosion member 130A is exaggerated. In the first embodiment, the bus bar 110 is configured as an aluminum/copper composite material (cladding material). Specifically, the bus bar 110 is configured as a combination of a positive electrode terminal connection portion 110a formed of an aluminum coupled with a negative electrode terminal connection portion 110c formed of a copper. The bus bar 110 has an interface 115 between the aluminum region and the copper region at a central position along the longitudinal direction.

The positive electrode terminal connection portion 110a is connected to the positive electrode external terminal 141 of a given cell 100A by laser welding. The negative electrode terminal connection portion 110c is connected to the negative electrode external terminal 151 of a different cell 100B by laser welding.

The sacrificial anticorrosion member 130A is arranged such that it is in contact with both the positive electrode terminal connection portion 110a and the negative electrode terminal connection portion 110c of the bus bar 110. The sacrificial anticorrosion member 130A is formed of a material having a potential lower than that of aluminum, i.e., a material having an ionization tendency greater than that of aluminum.

The sacrificial anticorrosion member 130A is preferably formed of a pure magnesium material or a magnesium alloy material (which will be referred to as a “magnesium” hereafter). Such a pure magnesium is not restricted to a magnesium material having a purity of 100% and it may containing impurities inevitably mixed in an ordinary refining process or an ordinary manufacturing process. Such a magnesium alloy may contain impurities so long as it contains magnesium with the highest content among its components. That is to say, such a magnesium alloy represents an alloy containing magnesium as its major component. In a case in which the sacrificial anticorrosion member 130A is formed of a magnesium alloy, from the anticorrosion viewpoint, the sacrificial anticorrosion member 130A preferably contains magnesium with a content of 10% or more, and more preferably contains magnesium with a content of 90% or more. Even in a case in which the sacrificial anticorrosion member 130A is formed of an aluminum alloy containing magnesium with a content on the order of 10% from the economic viewpoint, the sacrificial anticorrosion member 130A has a standard oxidation-reduction potential that is lower than that of aluminum and thus, the sacrificial anticorrosion member 130A has a sufficient anticorrosion effect.

As the sacrificial anticorrosion member 130A, a magnesium foil may be employed. The sacrificial anticorrosion member 130A is arranged over the entire circumference of the outer face of the bus bar 110 so as to cover the interface 115. The sacrificial anticorrosion member 130A and the outer face of the bus bar 110 are bonded by means of an adhesive agent having electrical conductivity.

It should be noted that, instead of such a magnesium foil shown in FIG. 5(b), a magnesium plate may be employed as the sacrificial anticorrosion member as shown in FIG. 5(c). In this case, the magnesium plate may be stacked at a predetermined position on the bus bar 110 and extended by applying pressure, and may be subjected to heat processing so as to provide diffusion bonding, such that it is monolithically integrated with the bus bar 110. With such an arrangement, the magnesium plate is also coupled with the bus bar 110 at the same time as when the aluminum plate (positive electrode terminal connection portion 110a) and the copper plate (negative electrode terminal connection portion 110c) of the bus bar 110 are coupled with each other, thereby providing improved manufacturing efficiency. Such an arrangement allows surface anticorrosion processing to be performed on the surface of the magnesium plate by using sodium salt or the like in a simple manner. Thus, such an arrangement is capable of suppressing corrosion in the sacrificial anticorrosion layer itself, thereby maintaining a sacrificial anticorrosion effect over a long period of time. Furthermore, the positive electrode terminal connection portion 110a of the bus bar 110 may be subjected to alumite treatment so as to provide the positive electrode terminal connection portion 110a with an improved anticorrosion function.

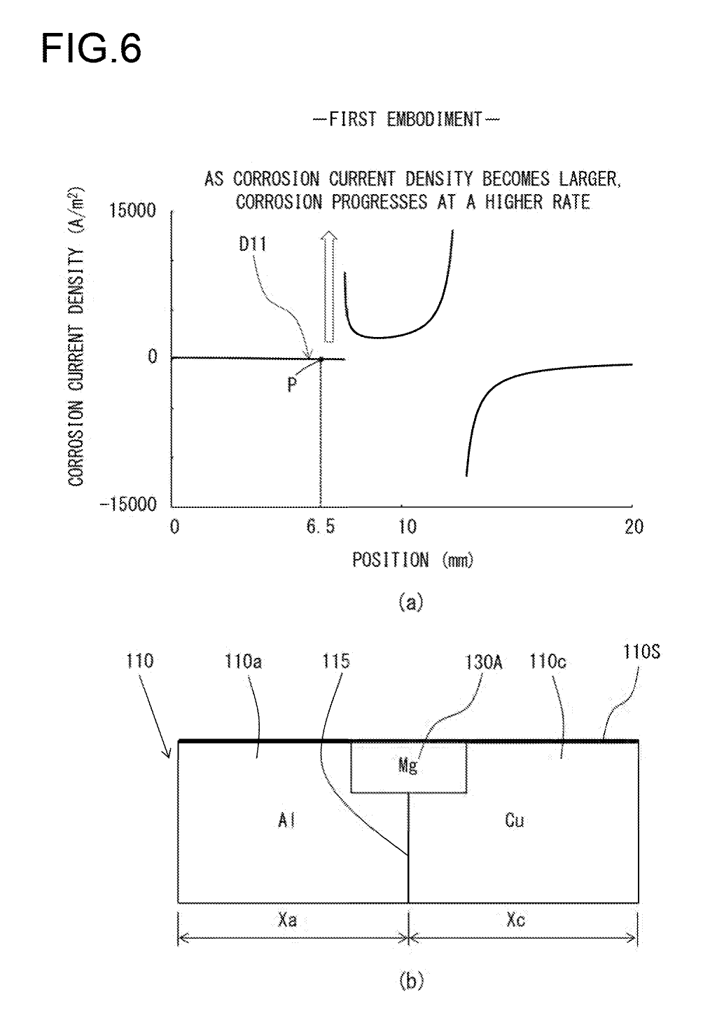

In order to evaluate the anticorrosion effect resulting from the sacrificial anticorrosion member 130A provided to the assembled battery according to the first embodiment, numerical analysis was performed using a finite element method. FIG. 6(a) is a diagram showing the analysis results of the corrosion current density on the corrosion surface of the bus bar 110 shown in FIG. 5. FIG. 6(b) is a diagram showing an analysis model of the bus bar 110 shown in FIG. 5.

As shown in FIG. 6(b), the present analysis model is designed to analyze a combination of the magnesium plate and the bus bar 110 which are monolithically integrated (see FIG. 5(c)). The analysis model is designed assuming that water containing salt adheres to a corrosion surface 101S, and that the surface of the bus bar 110 is in contact with an electrolytic substance having an electroconductivity of 7.95 S/rm. The analysis model is designed assuming that aluminum has a standard oxidation-reduction potential of −1.676 V, copper has a standard oxidation-reduction potential of 0.340 V, magnesium has a standard oxidation-reduction potential of −2.356 V, and nickel has a standard oxidation-reduction potential of −0.257 V. In this model, the terminal of the assembled battery and the bus bar are assumed to have the same sizes as those of a typical prismatic lithium-ion secondary battery and a typical bus bar. Specifically, the analysis model is designed assuming that the aluminum region has a length Xa of 50 mm, and the copper region has a length Xc of 50 mm. Furthermore, the analysis model is designed assuming that the magnesium region is configured at a central position of the bus bar 110 along the longitudinal direction, and has a length of 5 mm.

In the graph shown in FIG. 6(a), the horizontal axis represents the position coordinate in the longitudinal direction of the bus bar, and the vertical axis represents the corrosion current density on the corrosion surface 110S. The position coordinate along the horizontal axis is defined assuming that the center of the bus bar 110 along the longitudinal direction in the analysis model is set at a position of 10 mm. As the corrosion current density becomes larger in the positive direction, the rate at which a metal material dissolves in the electrolytic substance becomes higher and corrosion progresses at a higher rate.

It should be noted that a sudden change occurs in the physical properties at the interface between different metal materials. Thus, the corrosion surface 110S on the dissimilar metal interfaces (the interface between the aluminum and the magnesium, and the interface between the magnesium and the copper) is calculated as a singularity in the finite element analysis. In the vicinity of such a singularity, the current density distribution exhibits an infinite value or otherwise oscillating behavior. Thus, the calculation results in the vicinity of the singularity are not shown. That is to say, the calculation results are shown for a range at a predetermined distance from the singularity, i.e., a range in which stable calculation results are obtained. Such calculation results are sufficient to understand the corrosion that may occur in each material surface region.

As shown in FIG. 6(a), with the first embodiment, the corrosion current density D11 exhibits a small absolute value over the entire region of the aluminum. In particular, the corrosion current density D11 exhibits a markedly small value in the vicinity of the interface between the aluminum and the magnesium as compared with Examples (1) and (2) described later. For example, a corrosion current density of approximately 3 A/m² is achieved at a position approximately 1 mm from the interface between the aluminum and the magnesium, i.e., at a 6.5-mm coordinate point P. Thus, it can be confirmed that such an arrangement can be expected to provide a very great corrosion suppression effect. This means that there is almost no reduction in the thickness of the aluminum region, i.e., there is almost no reduction in the thickness of the positive electrode terminal connection portion 110a of the bus bar 110, due to corrosion. That is to say, such an arrangement effectively provides an aluminum anticorrosion function using the sacrificial anticorrosion effect. In contrast, the corrosion current density distribution in the magnesium region, i.e., the corrosion current density distribution in the sacrificial anticorrosion member 130A exhibits a large positive value in the vicinity of the interface between the magnesium and the aluminum and between the magnesium and the copper. Thus, it can be confirmed that the corrosion of the magnesium progresses instead of the aluminum, and that the magnesium member provides the sacrificial anticorrosion effect.

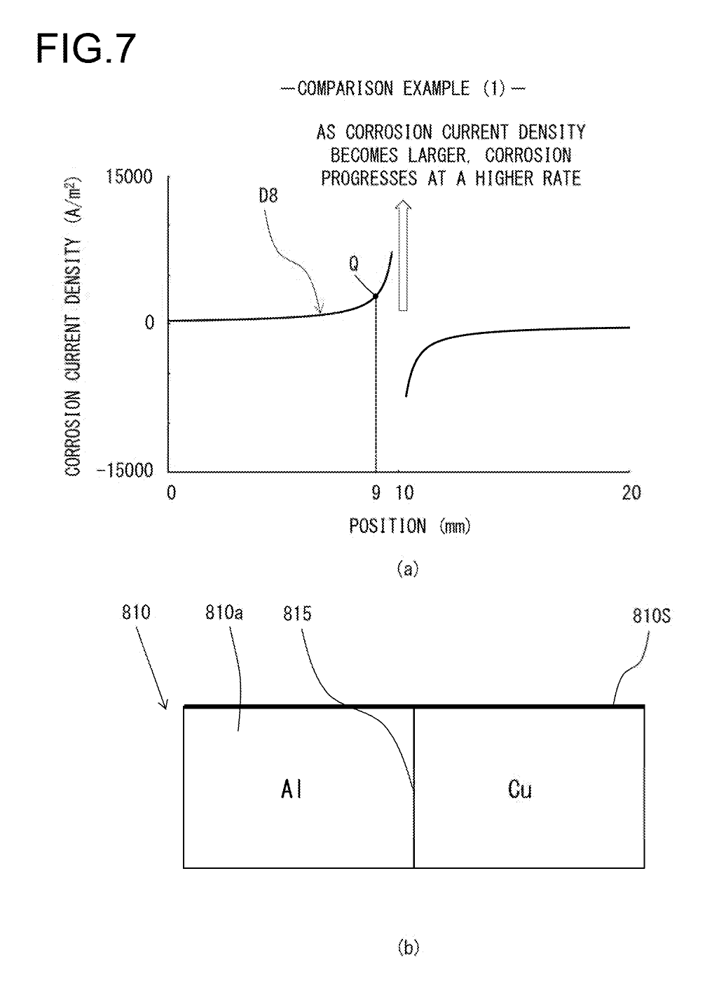

FIG. 7 shows diagrams illustrating the comparison example (1). FIG. 7(a) is a diagram showing the analysis results of the corrosion current density on a corrosion surface 810S of a bus bar 810 having no sacrificial anticorrosion member. FIG. 7(b) is a diagram showing an analysis model of the bus bar 810 having no sacrificial anticorrosion member.

As shown in FIG. 7(b), the comparison example (1) has no sacrificial anticorrosion member 130A. Thus, as shown in FIG. 7(a), the corrosion current density distribution D8 in the aluminum region exhibits a positive value over the entire region of the aluminum region. As the position approaches an interface 815 between the aluminum and the copper, the corrosion current density distribution D8 becomes larger in the positive direction. This result means that the corrosion progresses in the aluminum region in the vicinity of the interface 815 between the aluminum and the copper, i.e., in a positive electrode terminal connection portion 810a of the bus bar 110.

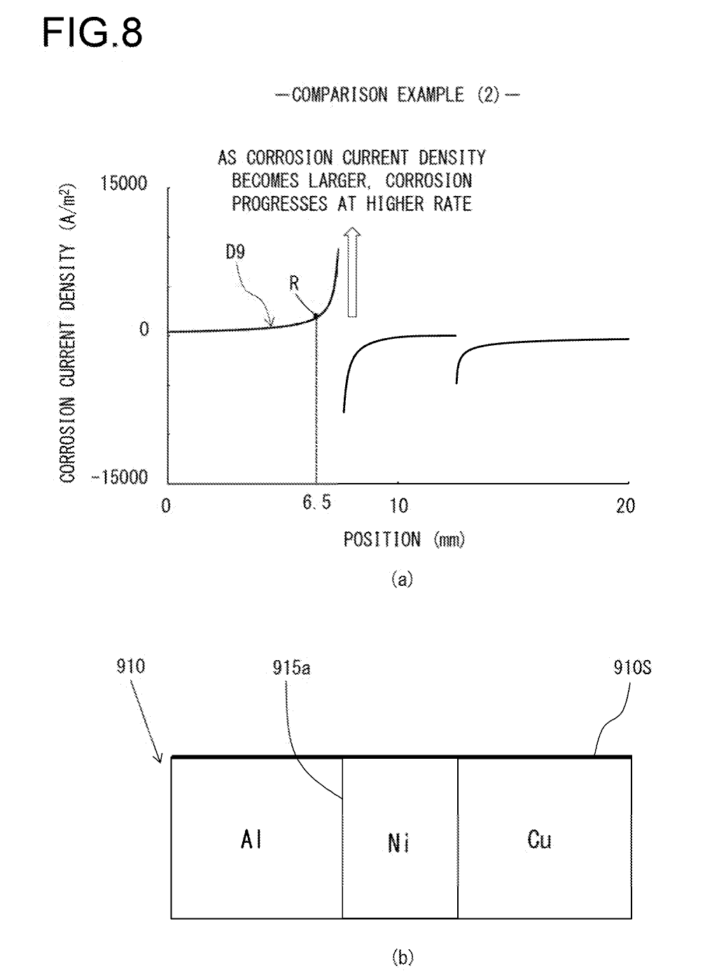

FIG. 8 shows diagrams illustrating the comparison example (2). FIG. 8(a) is a diagram showing the analysis results of the corrosion current density on a corrosion surface 910S of a bus bar 910 having a nickel between the aluminum and the copper. FIG. 8(b) is a diagram showing an analysis model of the bus bar 910 having a nickel between the aluminum and the copper.

As shown in FIG. 8(b), with the comparison example (2), a nickel, having an ionization tendency that is greater than that of copper and that is smaller than that of aluminum, is interposed between the aluminum and the copper. It should be noted that the analysis model of the comparison example (2) is designed assuming that the nickel region has a length of 5 mm. As shown in FIG. 8(a), the corrosion current density distribution D9 in the aluminum region exhibits a positive value over the entire region of the aluminum region. As the position approaches an interface 915a between the aluminum and the nickel, the corrosion current density distribution D9 becomes larger in the positive direction. This result means that the corrosion of the aluminum progresses in the vicinity of the interface 915a between the aluminum and the nickel.

With the comparison example (2), the electrochemical potential difference between the aluminum and the nickel is small as compared with that between the aluminum and the copper. Thus, such an arrangement suppresses the progress of galvanic corrosion in the aluminum, as compared with the comparison example (1) having no anticorrosion measure. For example, with the comparison example (1), the corrosion current density exhibits approximately 2900 A/m² at a position approximately 1 mm from the interface 815 between the copper and the aluminum, i.e., at a 9-mm coordinate point Q. In contrast, with the comparison example (2), the corrosion current density exhibits approximately 2000 A/m² at a position approximately 1 mm from the interface 915a between the nickel and the aluminum, i.e., at a 6.5-mm coordinate point R. That is to say, the corrosion current density at the point R in the comparison example (2) is approximately ⅔ of that at the point Q in the comparison example (1). Thus, it can be confirmed that the comparison example (2) suppresses the corrosion of the aluminum as compared with the comparison example (1).

As described above, it can be confirmed that the present embodiment provides an improved anticorrosion suppression effect as compared with the comparison examples (1) and (2) based on the analysis results of the present embodiment and the analysis results of the comparison examples (1) and (2).

With the first embodiment described above, the following effects and advantages are provided.

The assembled battery is formed of the cells 100 which are electrically connected by means of the bus bars 110. In each bus bar 110, the aluminum/copper interface 115 is formed by coupling the positive electrode terminal connection portion 110a formed of the aluminum with the corresponding negative electrode terminal connection portion 110c formed of the copper in a current path of the charge/discharge current. The bus bar 110 is provided with the sacrificial anticorrosion member 130A arranged such that it is in contact with both the positive electrode terminal connection portion 110a formed of the aluminum and the negative electrode terminal connection portion 110c formed of the copper. The sacrificial anticorrosion member 130A is formed of the magnesium having an ionization tendency that is greater than that of aluminum. With such an arrangement, first-stage corrosion readily occurs in the sacrificial anticorrosion member 130A. This suppresses the occurrence of corrosion in the aluminum. As a result, such an arrangement is capable of preventing an increase in the contact resistance due to corrosion that occurs in the interface 115, thereby preventing a reduction in the output of the battery over a long period of time.

### Modification (1) of the First Embodiment

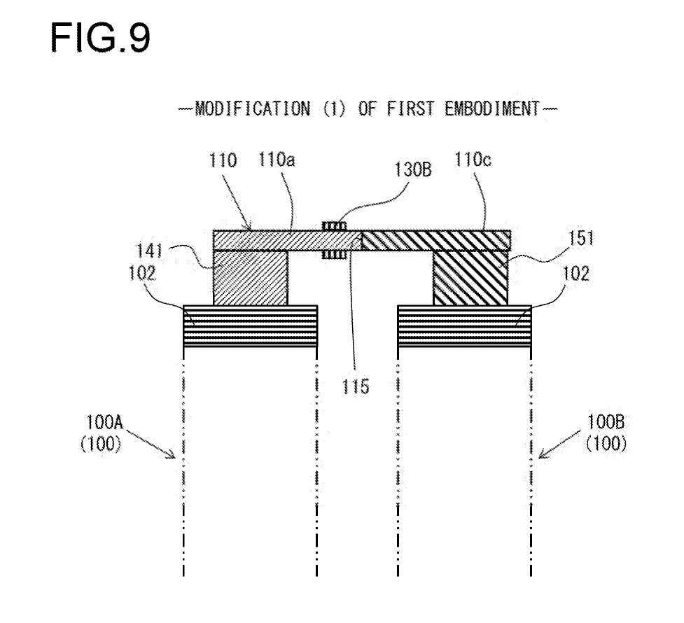

Referring to FIGS. 9 through 12, description will be made regarding an assembled battery according to a modification (1) of the first embodiment. It should be noted that the same or the corresponding portions as those in the first embodiment are denoted by the same reference numerals, and description will be mainly made regarding the points of difference. FIG. 9 is a diagram showing a sacrificial anticorrosion member 130B provided to the bus bar 110 according to the modification (1) of the first embodiment.

In the first embodiment, as shown in FIG. 5, the sacrificial anticorrosion member 130A is arranged such that it is in contact with both the positive electrode terminal connection portion 110a and the negative electrode terminal connection portion 110c of the bus bar 110. In contrast, in the modification (1) of the first embodiment, as shown in FIG. 9, the sacrificial anticorrosion member 130B is arranged such that it is in contact with only the positive electrode terminal connection portion 110a.

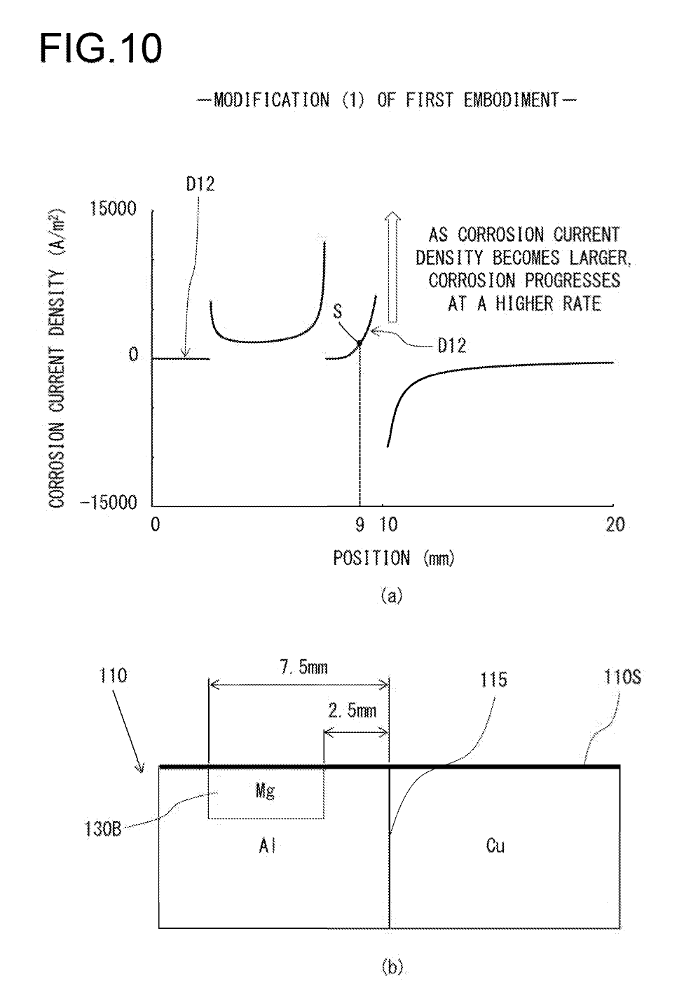

FIG. 10(a) is a diagram showing the analysis results of the corrosion current density on the corrosion surface 110S of the bus bar 110 shown in FIG. 9. FIG. 10(b) is a diagram showing an analysis model of the bus bar 110 shown in FIG. 9. In the first embodiment, as shown in FIG. 6(b), the magnesium region is arranged at a central portion of the bus bar 110 in the longitudinal direction. In contrast, in the modification (1) of the first embodiment, as shown in FIG. 10(b), the magnesium region is arranged in the aluminum region at a distance of 2.5 mm to 7.5 mm from the interface 115.

As shown in FIG. 10(a), with the modification (1) of the first embodiment, the corrosion current density distribution D12 in the aluminum region exhibits almost zero in the vicinity of an interface between the magnesium region and part of the aluminum region. It should be noted that, as the position approaches the interface 115 between the aluminum and the copper, the corrosion current density distribution D12 in the aluminum region becomes larger in the positive direction. However, the magnitude of the corrosion current density is small as compared with those in the comparison examples (1) and (2).

For example, with the modification (1) of the first embodiment, the corrosion current density exhibits approximately 1500 A/m² at a position of approximately 1 mm from the interface 115 between the copper and the aluminum, i.e., the 9-mm coordinate point S. This value is small as compared with the corrosion current density of approximately 2900 A/m² at the point Q in the comparison example (1) and the corrosion current density of approximately 2000 A/m² at the point R in the comparison example (2). From the results thus obtained, it can be clearly understood that modification (1) of the first embodiment has an advantage as compared with the comparison examples (1) and (2).

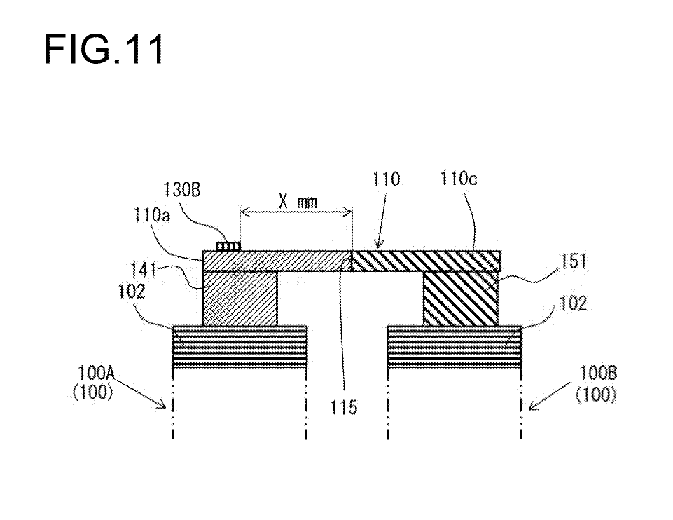

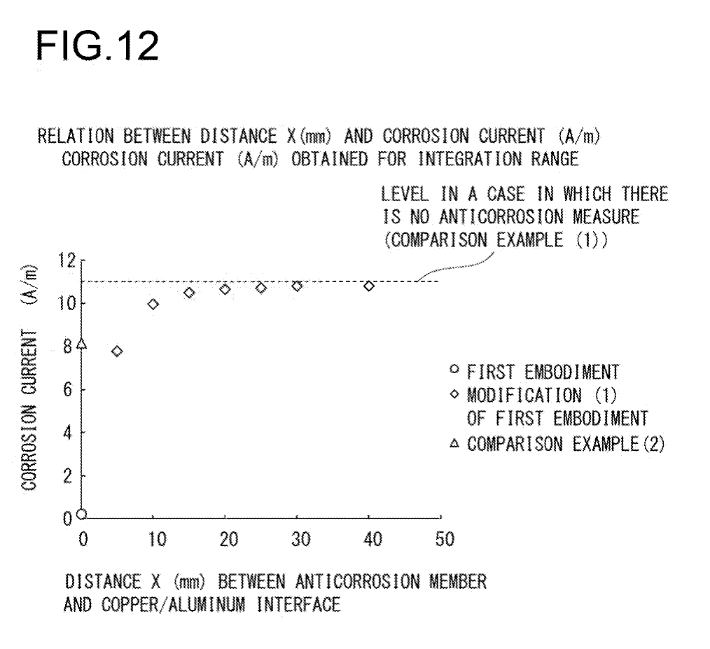

FIG. 11 is a diagram for describing the relation between the aluminum/copper interface 115 and the distance X between the interface and the sacrificial anticorrosion member 130B. FIG. 12 is a graph showing the relation between the corrosion current and the distance X shown in FIG. 11, and showing the dependency of the corrosion current on an attaching position of the sacrificial anticorrosion member 130B. The graph shown in FIG. 12 is obtained by analyzing the corrosion current density according to the distance X, and integrating the current density over a range of 5 mm from the interface 115 so as to calculate the corrosion current. It should be noted that, in order to provide two-dimensional calculation, the graph is obtained with the corrosion current expressed as units of “A/m” assuming that the thickness of the depth direction is a unit length of 1 min. The values in the vicinity of the dissimilar metal interface are obtained by estimating and integrating the calculation results obtained by means of polynomial (6-th order) approximation based on the corrosion current density calculation results for a region at a distance from the interface.

In FIG. 12, the calculation results are plotted in a case in which the sacrificial anticorrosion member 130A is arranged at a position of X=0 mm, which is a calculation condition according to the first embodiment, and in a case in which the sacrificial anticorrosion member 130B is arranged at respective positions of X=5, 10, 15, 20, 25, 30, and 40 mm, which are calculation conditions according to the modification (1) of the first embodiment. Furthermore, the calculation results according to comparison example (2) are also plotted together. Moreover, the calculation results according to the comparison example (1) having no anticorrosion measure are represented by the broken line.

As shown in FIG. 12, it has been found that, in a case in which the sacrificial anticorrosion member 130B is arranged at a position at a distance X from the interface 115 between the aluminum and the copper, as the distance X becomes greater, the corrosion current becomes larger. In other words, it can be understand that, as the distance X becomes smaller, the anticorrosion effect becomes greater. It should be noted that the corrosion current increases according to an increase in the distance X. However, the value of the corrosion current is small as compared with that in the comparison example (1) having no anticorrosion measure. That is to say, it can be understood that, with the modification (1) of the first embodiment, even in a case in which the sacrificial corrosion member 130B is arranged at a position at a distance from the interface 115, e.g., at a distance of X=40 mm from the interface 115, such an arrangement still provides an anticorrosion effect as compared with an arrangement having no anticorrosion measure. It should be noted that such a sacrificial anticorrosion member may preferably be arranged at a position determined so as to provide a sufficient anticorrosion effect according to the use environment of the assembled battery giving consideration to the aforementioned corrosion current value.

As described above, with the modification (1) of the first embodiment in which the sacrificial anticorrosion member 130B is arranged such that it is in contact with only the positive electrode terminal connection portion 110a, such an arrangement provides the effects and functions for suppressing corrosion of the aluminum by means of the sacrificial anticorrosion effect in the same manner as in the first embodiment.

### Modification (2) of the First Embodiment

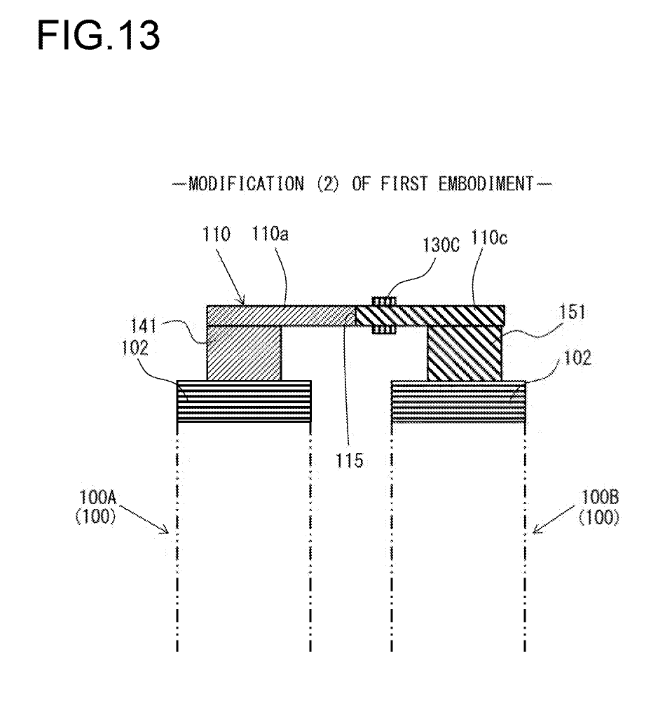

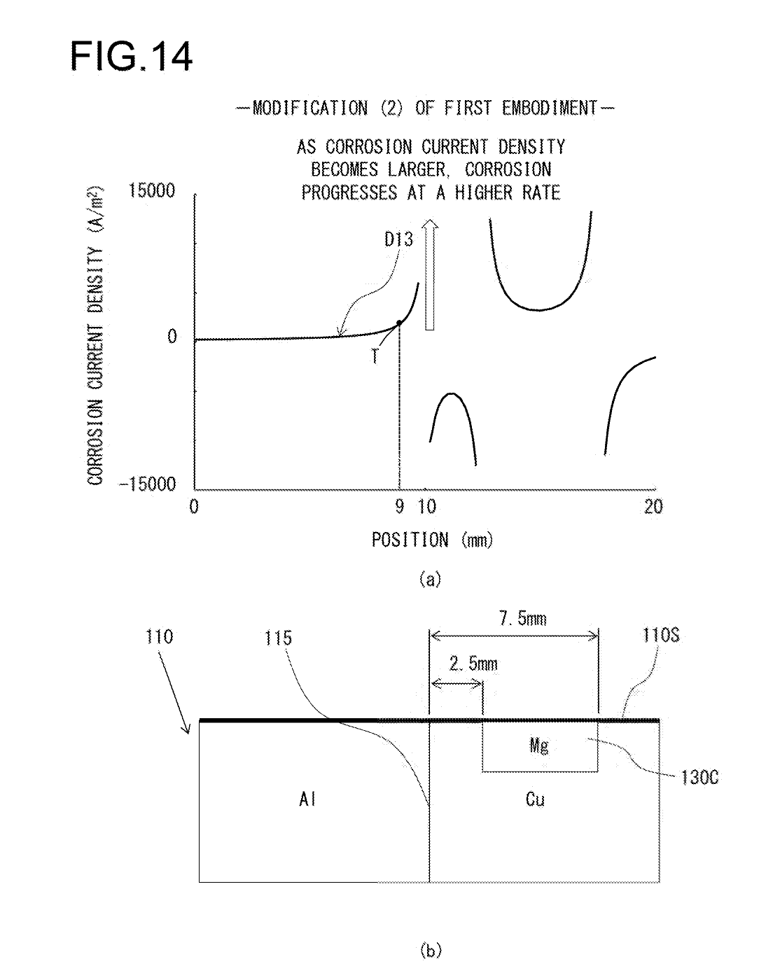

Referring to FIGS. 13 and 14, description will be made regarding an assembled battery according to a modification (2) of the first embodiment. It should be noted that the same or the corresponding portions as those in the first embodiment are denoted by the same reference numerals, and description will be mainly made regarding the points of difference. FIG. 13 is a diagram showing a sacrificial anticorrosion member 130C provided to the bus bar 110 according to the modification (2) of the first embodiment.

In the modification (2) of the first embodiment, as shown in FIG. 13, a sacrificial anticorrosion member 130C is arranged such that it is in contact with only the negative electrode terminal connection portion 110c.

FIG. 14(a) is a diagram showing the analysis results of the corrosion current density on the corrosion surface 110S of the bus bar 110 shown in FIG. 13. FIG. 14(b) is a diagram showing an analysis model of the bus bar 110 shown in FIG. 13. In the modification (2) of the first embodiment, as shown in FIG. 14(b), the magnesium region is arranged in the copper region at a distance of 2.5 mm to 7.5 mm from the interface 115.

As shown in FIG. 14(a), with the modification (2) of the first embodiment, as the position approaches the interface 115 between the aluminum and the copper, the corrosion current density distribution D13 in the aluminum region becomes larger in the positive direction. However, the magnitude of the corrosion current density is small as compared with that in the comparison example (1).

For example, with the modification (2) of the first embodiment, the corrosion current density exhibits approximately 2000 A/m² at a position at a distance of approximately 1 mm from the interface 115 between the copper and the aluminum, i.e., the 9-mm coordinate point T. This value is small as compared with the corrosion current density of approximately 2900 A/m² at the point Q in the comparison example (1). From the results thus obtained, it can be understood that modification (1) of the first embodiment has an advantage as compared with the comparison example (1). It should be noted that the corrosion current density represented by the point T in the corrosion current density distribution D13 in the modification (2) of the first embodiment is almost the same as that represented by the point R in the comparison example (2). That is to say, by arranging the sacrificial anticorrosion member 130C in the vicinity of the interface 115 between the aluminum and the copper such that it is closer than that of the sacrificial anticorrosion member 130C shown in the modification (2) of the first embodiment, such an arrangement provides a higher anticorrosion effect than that provided by the comparison example (2). Thus, the sacrificial anticorrosion member 130C may preferably be arranged at a position determined so as to provide a sufficient anticorrosion effect according to the use environment of the assembled battery giving consideration to the aforementioned corrosion current density value.

As described above, with the modification (2) of the first embodiment, such an arrangement provides the effects and functions for suppressing corrosion of the aluminum by means of the sacrificial anticorrosion effect in the same manner as in the first embodiment.

### Modification (3) of the First Embodiment

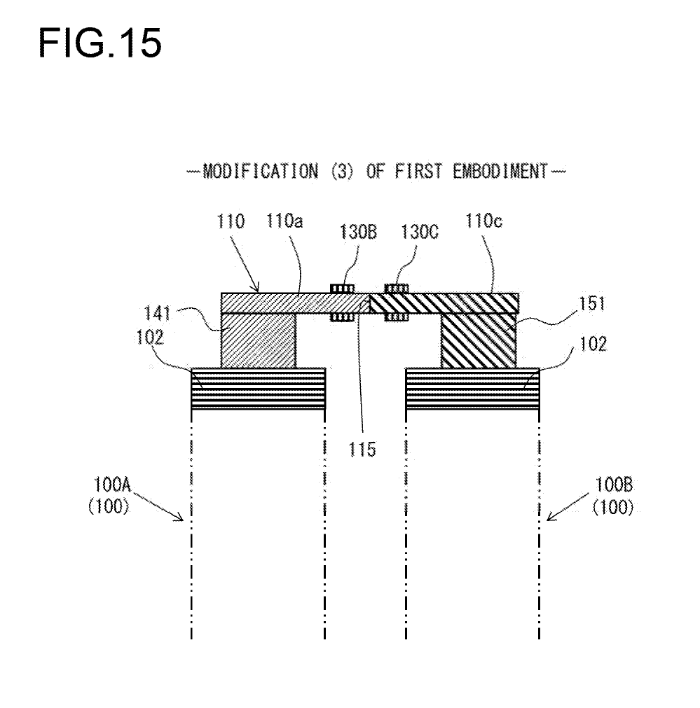

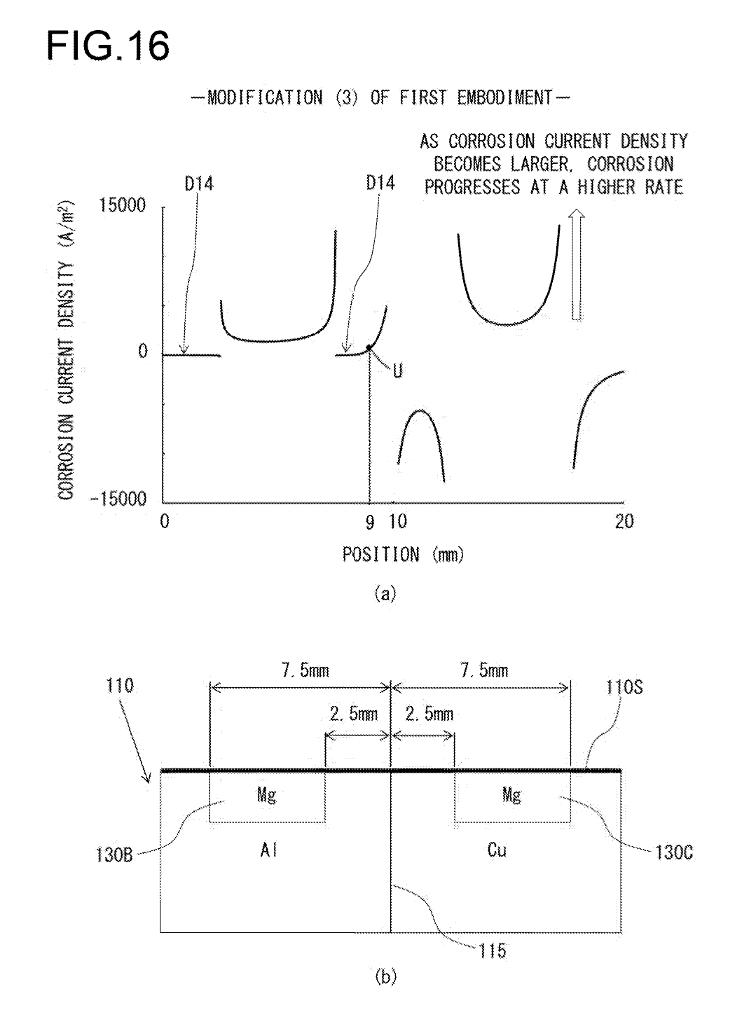

Referring to FIGS. 15 and 16, description will be made regarding an assembled battery according to a modification (3) of the first embodiment. It should be noted that the same or the corresponding portions as those in the modifications (1) and (2) of the first embodiment are denoted by the same reference numerals, and description will be mainly made regarding the points of difference. FIG. 13 is a diagram showing a sacrificial anticorrosion member 130B and a sacrificial anticorrosion member 130C provided to the bus bar 110 according to the modification (3) of the first embodiment.

As shown in FIG. 15, the assembled battery according to the modification (3) of the first embodiment includes the sacrificial anticorrosion member 130B arranged such that it is in contact with only the positive electrode terminal connection portion 110a, and the sacrificial anticorrosion member 130C arranged such that it is in contact with only the negative electrode terminal connection portion 110c. That is to say, the assembled battery according to the modification (3) of the first embodiment has a configuration obtained by combining the modifications (1) and (2) of the first embodiment described above.

FIG. 16(a) is a diagram showing the analysis results of the corrosion current density on the corrosion surface 100S of the bus bar 110 shown in FIG. 15. FIG. 16(b) is a diagram showing an analysis model of the bus bar 110 shown in FIG. 15. In the modification (3) of the first embodiment, as shown in FIG. 16(b), a magnesium region is arranged in the aluminum region at a distance of 2.5 mm to 7.5 mm from the interface 115. Furthermore, another magnesium region is arranged in the copper region at a distance of 2.5 mm to 7.5 mm from the interface 115.

As shown in FIG. 16(a), with the modification (3) of the first embodiment, as the position approaches the interface 115 between the aluminum and the copper, the corrosion current density distribution D14 in the aluminum region becomes larger in the positive direction. However, the magnitude of the corrosion current density is small as compared with those in the comparison examples (1) and (2).

For example, with the modification (3) of the first embodiment, the corrosion current density exhibits approximately 700 A/m² at a distance at a distance of approximately 1 mm from the interface 115 between the copper and the aluminum, i.e., the 9-mm coordinate point U. This value is small as compared with the corrosion current density of approximately 2900 A/m² at the point Q in the comparison example (1), and the corrosion current density of approximately 2000 A/m² at the point R in the comparison example (2). From the results thus obtained, it can be clearly understood that modification (3) of the first embodiment has a great advantage as compared with the comparison examples (1) and (2).

As described above, with the modification (3) of the first embodiment, such an arrangement provides a function and effect for suppressing corrosion of an aluminum member by means of the sacrificial anticorrosion effect in the same manner as in the first embodiment.

### Second Embodiment

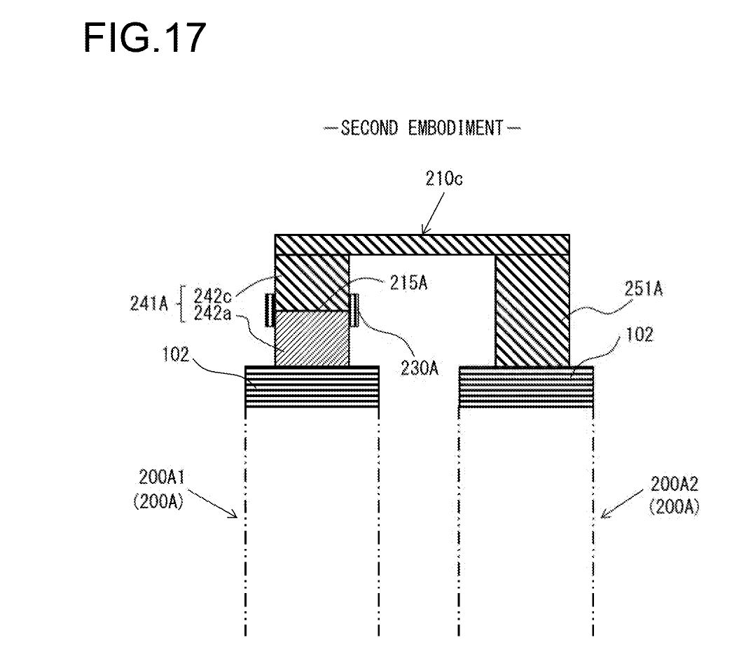

Referring to FIG. 17, description will be made regarding an assembled battery and a cell according to a second embodiment. It should be noted that the same or the corresponding portions as those in the first embodiment are denoted by the same reference numerals, and description will be mainly made regarding the points of difference. FIG. 17 is a diagram showing a sacrificial anticorrosion member 230A provided to a positive electrode external terminal 241A of a cell 200A that is a component of the assembled battery according to the second embodiment.

Description has been made in the first embodiment regarding an arrangement in which the bus bar 110 is formed of a cladding material obtained by coupling a copper material and an aluminum material. In contrast, in the second embodiment, a bus bar 210c is formed of a copper alone. That is to say, the bus bar 210c has no dissimilar metal interface.

Description has been made in the first embodiment regarding an arrangement in which the positive electrode external terminal 141 is formed of an aluminum. In contrast, in the second embodiment, the positive electrode external terminal 241A is formed as an aluminum/copper composite material (cladding material). Specifically, the positive electrode external terminal 241A is formed by coupling a base 242a formed of an aluminum with a bus bar connection portion 242c formed of a copper. The positive electrode external terminal 241A has an aluminum/copper interface 215A formed such that it extends in parallel with the battery cover 102. It should be noted that the positive electrode external terminal 241A is not restricted to such a cladding material and alternatively, it may be configured by coupling an aluminum and a copper by brazing or the like.

The base 242a is provided with a protrusion (not shown) that protrudes toward the battery cover 102 side in the same manner as in the first embodiment. The protrusion is arranged such that it passes through the battery cover 102, and is fixed by swaging to the terminal connection plate 181 of the positive electrode collector body 180. The face of the bus bar connection portion 242c that is opposite to the interface 215A is configured as a flat face that is to be in contact with the bus bar 210c. The negative electrode external terminal 251A has the same configuration as that in the first embodiment. Specifically, the negative electrode external terminal 25 IA is formed of a copper material alone.

The bus bar 210c is connected to the bus bar connection portion 242c of the positive electrode external terminal 241A of a given cell 200A1 and the negative electrode external terminal 251A of a different cell 200A2 by laser welding, thereby connecting the cells 200A1 and 200A2 in series. Multiple cells 200A are electrically connected so as to form an assembled battery.

In the second embodiment, the sacrificial anticorrosion member 230A is arranged such that it is in contact with both the base 242a and the bus bar connection portion 242c of the positive electrode external terminal 241A. A magnesium foil or a magnesium plate is employed as the sacrificial anticorrosion member 230A in the same way as in the first embodiment.

With the second embodiment described above, the following effects and advantages are provided.

With the cell 200A, the sacrificial anticorrosion member 230A is provided to the positive electrode external terminal 241A in which the interface 215A between an aluminum and a copper is formed in a current path of charge/discharge current by coupling the base 242a formed of the aluminum and the bus bar connection portion 242c formed of the copper. The sacrificial anticorrosion member 230A is arranged such that it is in contact with both the base 242a formed of the aluminum and the bus bar connection portion 242c formed of the copper. The sacrificial anticorrosion member 230A is formed of a magnesium having an ionization tendency that is greater than that of aluminum. With such an arrangement, first-stage corrosion readily occurs in the sacrificial anticorrosion member 230A. This suppresses the occurrence of corrosion in the aluminum member. As a result, such an arrangement is capable of preventing an increase in the contact resistance due to corrosion that occurs in the interface 215A, thereby preventing a reduction in the output of the battery over a long period of time.

It should be noted that, with the second embodiment, the attaching position of the sacrificial anticorrosion member 230A may be determined as appropriate so as to provide a sacrificial anticorrosion effect. The second embodiment is not restricted to such an arrangement in which the sacrificial anticorrosion member 230A is arranged such that it is in contact with both the base 242a and the bus bar connection portion 242c. The sacrificial anticorrosion member 230A may be arranged such that it is in contact with only the base 242a. Also, the sacrificial anticorrosion member 230A may be arranged such that it is in contact with only the bus bar connection portion 242c. Furthermore, a pair of sacrificial anticorrosion members 230A may be provided to the positive electrode external terminal 241A such that one is in contact with only the base 242a, and the other is in contact with only the bus bar connection portion 242c.

### Modification of the Second Embodiment

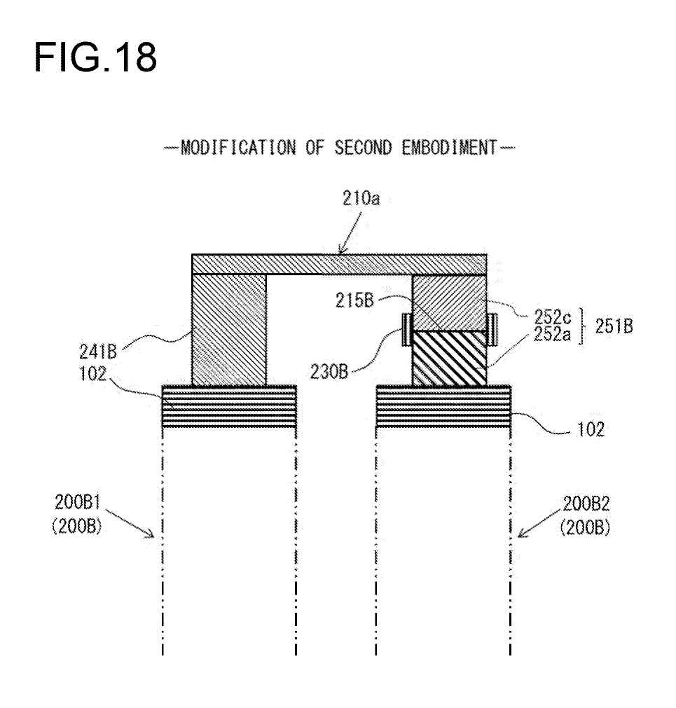

Referring to FIG. 18, description will be made regarding an assembled battery and a cell according to a modification of the second embodiment. It should be noted that the same or the corresponding portions as those in the second embodiment are denoted by the same reference numerals, and description will be mainly made regarding the points of difference. FIG. 18 is a diagram showing a sacrificial anticorrosion member 230B provided to a negative electrode external terminal 251B of a cell 200B that is a component of the assembled battery according to a modification of the second embodiment.

In the modification of the second embodiment, a bus bar 210a is formed of an aluminum material alone. The bus bar 210a has no dissimilar metal interface.

Description has been made in the second embodiment regarding an arrangement in which the positive electrode external terminal 241A is formed of a cladding material that comprises an aluminum material and a copper material, and the negative electrode external terminal 251A is formed of a copper material alone. In contrast, in the modification of the second embodiment, a positive electrode external terminal 241B is formed of an aluminum material alone, and the negative electrode external terminal 2518B is formed of an aluminum/copper composite material (cladding material). Specifically, the negative electrode external terminal 251B is formed by coupling a base 252a formed of a copper with a bus bar connection portion 252c formed of an aluminum. The negative electrode external terminal 251B has an aluminum/copper interface 2158B formed such that it extends in parallel with the battery cover 102. It should be noted that the negative electrode external terminal 251B is not restricted to such a cladding material. Also, the negative electrode external terminal 251B may be configured by coupling an aluminum material and a copper material by brazing or the like.

The base 252a is provided with a protrusion (not shown) that protrudes toward the battery cover 102 side in the same manner as in the first embodiment. The protrusion is arranged such that it passes through the battery cover 102, and is fixed by swaging to the terminal connection plate 191 of the negative electrode collector body 190. The face of the bus bar connection portion 252c that is opposite to the interface 215B is configured as a flat face that is to be in contact with the bus bar 210a. The positive electrode external terminal 241B has the same configuration as that in the first embodiment. Specifically, the positive electrode external terminal 241B is formed of an aluminum material alone.

The bus bar 210c is connected to the positive electrode external terminal 241B of a given cell 200B1 and the bus bar connection portion 252c of the negative electrode external terminal 25 IA of a different cell 200B2 by laser welding, thereby connecting the cells 200B1 and 200B2 in series. Multiple cells 200B are electrically connected so as to form an assembled battery.

In the modification of the second embodiment, the sacrificial anticorrosion member 230B is arranged such that it is in contact with both the base 252a and the bus bar connection portion 252c of the negative electrode external terminal 251B. A magnesium foil or a magnesium plate is employed as the sacrificial anticorrosion member 230B in the same way as in the first embodiment.

With the modification of the second embodiment described above, the following effects and advantages are provided.

With the cell 200B, the sacrificial anticorrosion member 230B is provided to the negative electrode external terminal 251A in which the interface 215B between an aluminum and a copper is formed in a current path of charge/discharge current by coupling the base 252a formed of the aluminum and the bus bar connection portion 252c formed of the copper. The sacrificial anticorrosion member 230B is arranged such that it is in contact with both the base 252a formed of the copper and the bus bar connection portion 252c formed of the aluminum. The sacrificial anticorrosion member 230B is formed of a magnesium having an ionization tendency that is greater than that of aluminum. With such an arrangement, first-stage corrosion readily occurs in the sacrificial anticorrosion member 230B. This suppresses the occurrence of corrosion in the aluminum member. As a result, such an arrangement is capable of preventing an increase in the contact resistance due to corrosion that occurs in the interface 215B, thereby preventing a reduction in the output of the battery over a long period of time.

It should be noted that, with the modification of the second embodiment, the mounting position of the sacrificial anticorrosion member 230B may be determined as appropriate so as to provide a sacrificial anticorrosion effect. This modification is not restricted to such an arrangement in which the sacrificial anticorrosion member 230B is arranged such that it is in contact with both the base 252a and the bus bar connection portion 252c. Also, the sacrificial anticorrosion member 230B may be arranged such that it is in contact with only the base 252a. Also, the sacrificial anticorrosion member 230B may be arranged such that it is in contact with only the bus bar connection portion 252c. Also, a pair of sacrificial anticorrosion members 230B may be provided to the negative electrode external terminal 251B such that one is in contact with only the base 252a, and the other is in contact with only the bus bar connection portion 252c.

### Third Embodiment

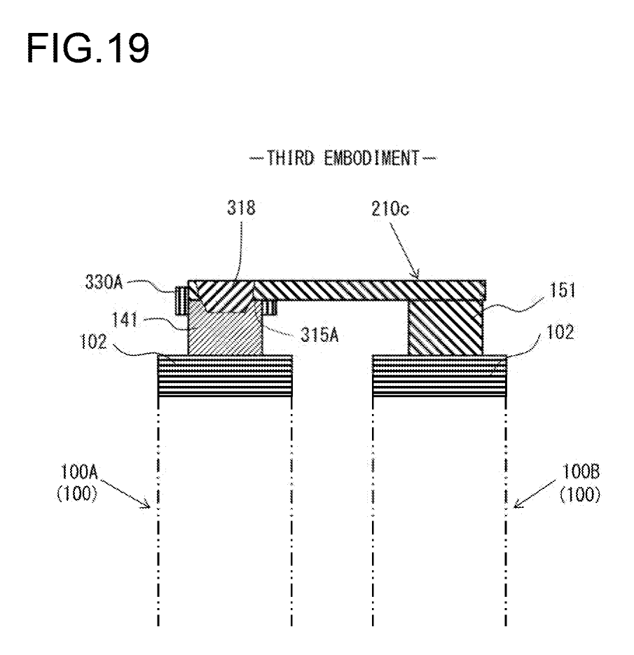

Referring to FIG. 19, description will be made regarding an assembled battery and a cell according to a third embodiment. It should be noted that the same or the corresponding portions as those in the first and second embodiments are denoted by the same reference numerals, and description will be mainly made regarding the points of difference. FIG. 19 is a diagram showing a sacrificial anticorrosion member 330A arranged such that it is in contact with both the bus bar 210c of the assembled battery and the positive electrode external terminal 141 of the cell 100 according to the third embodiment. The cell 100 according to the third embodiment has the same configuration as that in the first embodiment. The bus bar 210c has the same structure as that in the second embodiment.

In the third embodiment, the bus bar 210c is formed of a copper material alone, the positive electrode external terminal 141 is formed of an aluminum material alone, and the negative electrode external terminal 151 is formed of a copper material alone.

The bus bar 210c is connected to the positive electrode external terminal 141 of a given cell 100A and the negative electrode external terminal 151 of a different cell 100B by laser welding, thereby connecting the cells 100A and 100B in series. Multiple cells 100 are electrically connected so as to form an assembled battery. It should be noted that FIG. 19 shows only a welded portion (welded metal) 318 of the positive electrode external terminal 141, and a welded portion (welded metal) of the negative electrode external terminal 151 is not shown.

In the third embodiment, an aluminum/copper interface 315A is formed in a connection member obtained by combining the positive electrode external terminal 141 formed of the aluminum and the bus bar 210c formed of the copper. In the third embodiment, the sacrificial anticorrosion member 330A is arranged such that it is in contact with both the positive electrode external terminal 141 and the bus bar 210c.

With the third embodiment described above, the following effects and advantages are provided.

The assembled battery is provided with a connection member obtained by combining the positive electrode external terminal 141 formed of the aluminum and the bus bar 210c formed of the copper in a current path of the charge/discharge current. The aluminum/copper interface 315A is formed in the connection member. The sacrificial anticorrosion member 330A is arranged such that it is in contact with both the positive electrode external terminal 141 formed of the aluminum and the bus bar 210c formed of the copper. The sacrificial anticorrosion member 330A is formed of a magnesium material having an ionization tendency that is greater than that of aluminum. With such an arrangement, first-stage corrosion readily occurs in the sacrificial anticorrosion member 330A. This suppresses the occurrence of corrosion in the aluminum member. As a result, such an arrangement is capable of preventing an increase in the contact resistance due to corrosion that occurs in the interface 315A, thereby preventing a reduction in the output of the battery over a long period of time.

It should be noted that, with the third embodiment, the mounting position of the sacrificial anticorrosion member 330A may be determined as appropriate so as to provide a sacrificial anticorrosion effect. This embodiment is not restricted to such an arrangement in which the sacrificial anticorrosion member 330A is arranged such that it is in contact with both the positive electrode external terminal 141 and the bus bar 210c. Also, the sacrificial anticorrosion member 330A may be arranged such that it is in contact with only the positive electrode external terminal 141. Also, the sacrificial anticorrosion member 330A may be arranged such that it is in contact with only the bus bar 210c. Also, a pair of sacrificial anticorrosion members 330A may be provided such that one is in contact with only the positive electrode external terminal 141, and the other is in contact with only the bus bar 210c.

### Modification of the Third Embodiment

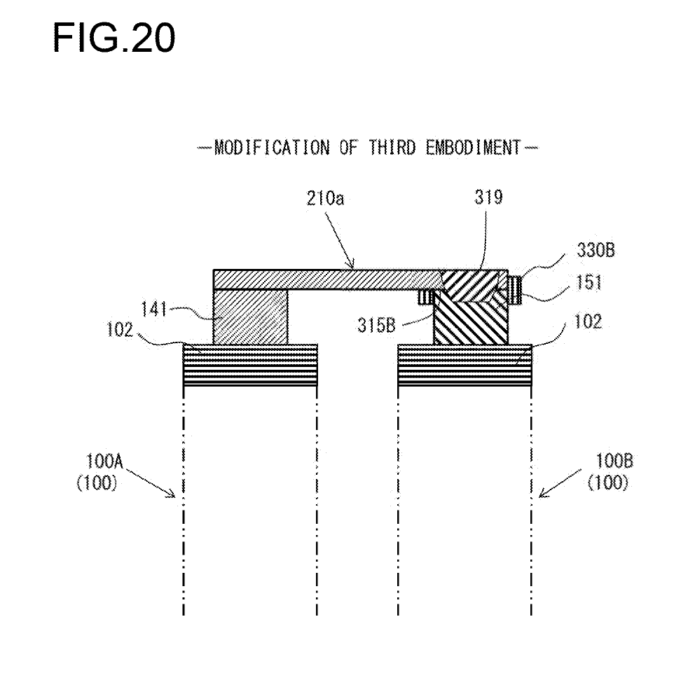

Referring to FIG. 20, description will be made regarding an assembled battery and a cell according to a modification of the third embodiment. It should be noted that the same or the corresponding portions as those in the first and second embodiments and the modifications thereof are denoted by the same reference numerals, and description will be mainly made regarding the points of difference. FIG. 20 is a diagram showing a sacrificial anticorrosion member 330B arranged such that it is in contact with both the bus bar 210a of the assembled battery and the negative electrode external terminal 151 of the cell 100 according to the modification of the third embodiment. The cell 100 according to the modification of the third embodiment has the same configuration as that in the first embodiment. The bus bar 210a has the same structure as that in the modification of the second embodiment.

In the modification of the third embodiment, the bus bar 210a is formed of an aluminum material alone. The positive electrode external terminal 141 is formed of an aluminum material alone. The negative electrode external terminal 151 is formed of a copper material alone.

The bus bar 210a is connected to the positive electrode external terminal 141 of a given cell 100A and the negative electrode external terminal 151 of a different cell 100B by laser welding, thereby connecting the cells 100A and 100B in series. Multiple cells 100 are electrically connected so as to form an assembled cell. It should be noted that FIG. 20 shows only a welded portion (welded metal) 319 of the negative electrode external terminal 151, and a welded portion (welded metal) of the positive electrode external terminal 141 is not shown.

In the modification of the third embodiment, an aluminum/copper interface 315B is formed in a connection member obtained by combining the negative electrode external terminal 151 formed of a copper and the bus bar 210a formed of an aluminum. In the modification of the third embodiment, the sacrificial anticorrosion member 330B is arranged such that it is in contact with both the negative electrode external terminal 151 and the bus bar 210a.

With the modification of the third embodiment described above, the following effects and advantages are provided.

The assembled battery is provided with a connection member obtained by combining the bus bar 210a formed of an aluminum and the negative electrode external terminal 151 formed of a copper in a current path of the charge/discharge current. The aluminum/copper interface 315B is formed in the connection member. The sacrificial anticorrosion member 330B is arranged such that it is in contact with both the bus bar 210a formed of the aluminum and the negative electrode external terminal 151 formed of the copper. The sacrificial anticorrosion member 330B is formed of a magnesium material having an ionization tendency that is greater than that of aluminum. With such an arrangement, first-stage corrosion readily occurs in the sacrificial anticorrosion member 330B. This suppresses the occurrence of corrosion in the aluminum member. As a result, such an arrangement is capable of preventing an increase in the contact resistance due to corrosion that occurs in the interface 315B, thereby preventing a reduction in the output of the battery over a long period of time.

It should be noted that, with the modification of the third embodiment, the mounting position of the sacrificial anticorrosion member 330B may be determined as appropriate so as to provide a sacrificial anticorrosion effect. This modification is not restricted to such an arrangement in which the sacrificial anticorrosion member 330B is arranged such that it is in contact with both the negative electrode external terminal 151 and the bus bar 210a. Also, the sacrificial anticorrosion member 330B may be arranged such that it is in contact with only the negative electrode external terminal 151. Also, the sacrificial anticorrosion member 330B may be arranged such that it is in contact with only the bus bar 210a. Also, a pair of sacrificial anticorrosion members 330B may be provided such that one is in contact with only the negative electrode external terminal 151, and the other is in contact with only the bus bar 210a.

### Fourth Embodiment

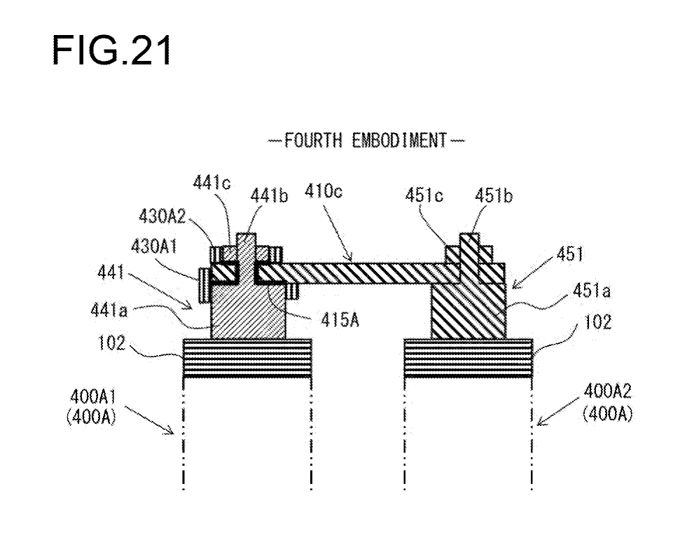

Referring to FIG. 21, description will be made regarding an assembled battery and a cell according to a fourth embodiment. It should be noted that the same or the corresponding portions as those in the first embodiment are denoted by the same reference numerals, and description will be mainly made regarding the points of difference. FIG. 21 is a diagram showing sacrificial anticorrosion members 430A1 and 430A2 each arranged such that it is in contact with both a bus bar 410c of the assembled battery and a positive electrode external terminal 441 of a cell 400A according to the fourth embodiment.

Description has been made in the first embodiment regarding an arrangement in which the positive electrode external terminal 141 and the negative electrode external terminal 151 are respectively provided with the flat faces 141s and 151s so as to be arranged such that they are in contact with the bus bar 110. Furthermore, the bus bar 110 is connected to the flat faces 141s and 151s by laser welding (see FIG. 1). In contrast, in the fourth embodiment, a bolt portion 441b is configured such that it protrudes from the flat face of the positive electrode external terminal 441. Furthermore, a bolt portion 451b is configured such that it protrudes from the flat face of a negative electrode external terminal 451.

In the fourth embodiment, the bus bar 410c is formed of a copper material alone. A through hole is formed in the bus bar 410c in the vicinity of its one end in the longitudinal direction, so as to allow the bolt portion 441b of the positive electrode external terminal 441 to pass through it. Furthermore, another through hole is formed in the bus bar 410c in the vicinity of its other end in the longitudinal direction, so as to allow the bolt portion 451b of the negative electrode external terminal 451 to pass through it.

By attaching a nut 441c to the bolt portion 441b of the positive electrode external terminal 441 of a given cell 400A1, and by attaching a nut 451c to the bolt portion 441b of the negative electrode external terminal 451 of a different cell 400A2, the cells 400A1 and 400A2 are connected in series via the bus bar 410c. Multiple cells 400A are electrically connected so as to form an assembled battery. It should be noted that the nut 441c is formed of an aluminum material, and the nut 451c is formed of a copper material.

In the fourth embodiment, an aluminum/copper interface 415A is formed in a connection member obtained by combining the positive electrode external terminal 441 formed of the aluminum and the bus bar 410c formed of the copper. In the fourth embodiment, the sacrificial anticorrosion member 430A 1 is arranged such that it is in contact with both the positive electrode external terminal 441 and the bus bar 410a. Furthermore, the sacrificial anticorrosion member 430A2 is arranged such that it is in contact with both the circumferential face of the nut 441c and the surface of the bus bar 410c around the nut 441c. It should be noted that, in the fourth embodiment, the sacrificial anticorrosion members 430A1 and 430A2 are preferably configured as a magnesium foil. With such an arrangement, the sacrificial anticorrosion members 430A1 and 430A2 can be easily mounted by means of an adhesion agent.

With the fourth embodiment described above, the following effects and advantages are provided.

The assembled battery is provided with a connection member obtained by combining the positive electrode external terminal 441 formed of an aluminum and the bus bar 410c formed of a copper in a current path of the charge/discharge current. The aluminum/copper interface 415A is formed in the connection member. The sacrificial anticorrosion member 430A1 is arranged such that it is in contact with both the positive electrode external terminal 441 formed of the aluminum and the bus bar 410c formed of the copper. The sacrificial anticorrosion member 430A1 is formed of a magnesium material having an ionization tendency that is greater than that of aluminum. With such an arrangement, first-stage corrosion readily occurs in the sacrificial anticorrosion member 430A1. This suppresses the occurrence of corrosion in the aluminum member. As a result, such an arrangement is capable of preventing an increase in the contact resistance due to corrosion that occurs in the interface 415A, thereby preventing a reduction in the output of the battery over a long period of time.

It should be noted that, with the fourth embodiment, the mounting position of the sacrificial anticorrosion member 430A1 may be determined as appropriate so as to provide a sacrificial anticorrosion effect. This embodiment is not restricted to such an arrangement in which the sacrificial anticorrosion member 430A 1 is arranged such that it is in contact with both the positive electrode external terminal 441 and the bus bar 410c. Also, the sacrificial anticorrosion member 430A1 may be arranged such that it is in contact with only the positive electrode external terminal 441. Also, the sacrificial anticorrosion member 430A1 may be arranged such that it is in contact with only the bus bar 410c. Also, a pair of sacrificial anticorrosion members 430A1 may be provided such that one is in contact with only the positive electrode external terminal 441, and the other is in contact with only the bus bar 410c.

### Modification of Fourth Embodiment

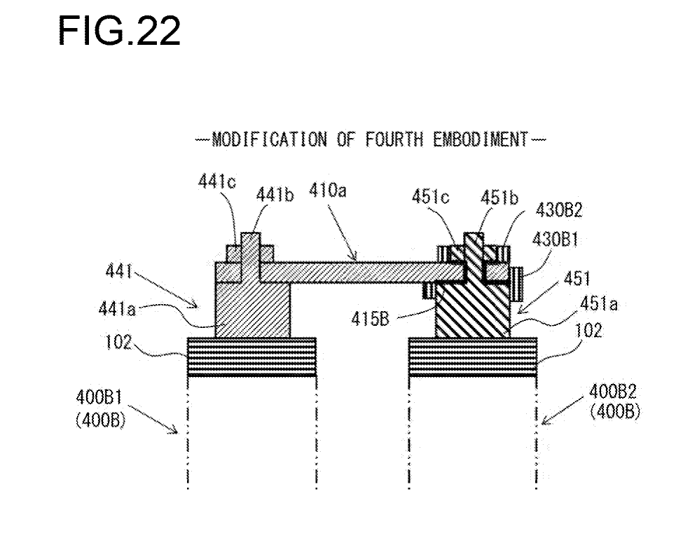

Referring to FIG. 22, description will be made regarding an assembled battery and a cell according to a modification of the fourth embodiment. It should be noted that the same or the corresponding portions as those in the fourth embodiment are denoted by the same reference numerals, and description will be mainly made regarding the points of difference. FIG. 22 is a diagram showing sacrificial anticorrosion members 430B1 and 430B2 each arranged such that it is in contact with both a bus bar 410a of the assembled battery and the negative electrode external terminal 451 of a cell 400B according to the fourth embodiment.

Description has been made in the fourth embodiment regarding an arrangement in which the bus bar 410c is formed of a copper material. In the modification of the fourth embodiment, the bus bar 410a is formed of an aluminum material.

By attaching the nut 441c to the bolt portion 441b of the positive electrode external terminal 441 of a given cell 400B1, and by attaching the nut 451c to the bolt portion 441b of the negative electrode external terminal 451 of a different cell 400B2, the cells 400B 1 and 400B2 are connected in series via the bus bar 410a. Multiple cells 400B are electrically connected so as to form an assembled battery. It should be noted that the nut 441c is formed of an aluminum material, and the nut 451c is formed of a copper material.

In the modification of the fourth embodiment, an aluminum/copper interface 415B is formed in a connection member obtained by combining the bus bar 410a formed of the aluminum and the negative electrode external terminal 451 formed of the copper. In the modification of the fourth embodiment, the sacrificial anticorrosion member 430B1 is arranged such that it is in contact with both the negative electrode external terminal 451 and the bus bar 410a. Furthermore, the sacrificial anticorrosion member 430B2 is arranged such that it is in contact with both the circumferential face of the nut 451c and the surface of the bus bar 410a around the nut 451c. It should be noted that, in the modification of the fourth embodiment, the sacrificial anticorrosion members 430B1 and 430B2 are preferably configured as a magnesium foil. With such an arrangement, the sacrificial anticorrosion members 430B1 and 430B2 can be easily mounted by means of an adhesive agent.

With the modification of the fourth embodiment described above, the following effects and advantages are provided.

The assembled battery is provided with a connection member obtained by combining the bus bar 410a formed of an aluminum and the negative electrode external terminal 451 formed of a copper in a current path of the charge/discharge current. The aluminum/copper interface 415B is formed in the connection member. The sacrificial anticorrosion member 430B1 is arranged such that it is in contact with both the bus bar 410a formed of the aluminum and the negative electrode external terminal 451 formed of the copper. The sacrificial anticorrosion member 430B1 is formed of a magnesium material having an ionization tendency that is greater than that of aluminum. With such an arrangement, first-stage corrosion readily occurs in the sacrificial anticorrosion member 430B 1. This suppresses the occurrence of corrosion in the aluminum member. As a result, such an arrangement is capable of preventing an increase in the contact resistance due to corrosion that occurs in the interface 415B, thereby preventing a reduction in the output of the battery over a long period of time.

It should be noted that, with the modification of the fourth embodiment, the mounting position of the sacrificial anticorrosion member 430B1 may be determined as appropriate so as to provide a sacrificial anticorrosion effect. This modification is not restricted to such an arrangement in which the sacrificial anticorrosion member 430B1 is arranged such that it is in contact with both the negative electrode external terminal 451 and the bus bar 410a. Also, the sacrificial anticorrosion member 430B1 may be arranged such that it is in contact with only the negative electrode external terminal 451. Also, the sacrificial anticorrosion member 430B 1 may be arranged such that it is in contact with only the bus bar 410a. Also, a pair of sacrificial anticorrosion members 430B 1 may be provided such that one is in contact with only the negative electrode external terminal 451, and the other is in contact with only the bus bar 410a.

### Fifth Embodiment

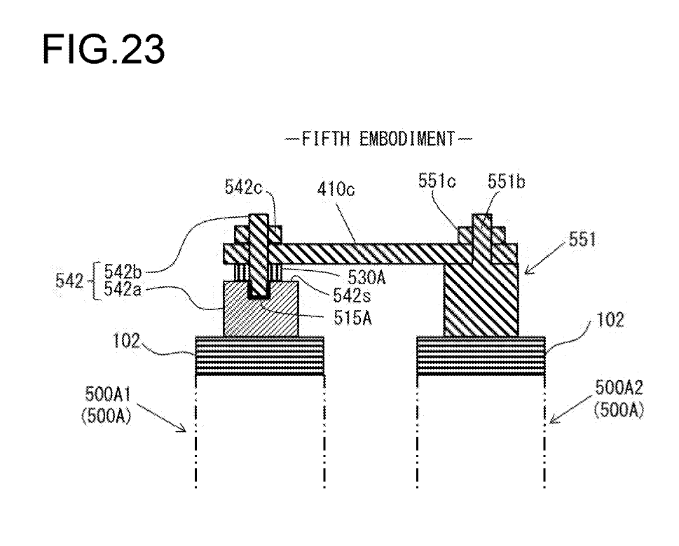

Referring to FIG. 23, description will be made regarding an assembled battery and a cell according to a fifth embodiment. It should be noted that the same or the corresponding portions as those in the fourth embodiment are denoted by the same reference numerals, and description will be mainly made regarding the points of difference. FIG. 23 is a diagram showing a sacrificial anticorrosion member 530A provided to a positive electrode external terminal 542 of a cell 500A that is a component of an assembled battery according to the fifth embodiment.

Description has been made in the fourth embodiment regarding an arrangement in which the positive electrode external terminal 441 is configured including the bolt portion 441b and the base 441a monolithically formed of the same material (see FIG. 21). In contrast, in the fifth embodiment, the positive electrode external terminal 441 comprises separate components, i.e., a bolt portion 542b formed of a copper material and a base 542a formed of an aluminum material. With such a positive electrode external terminal 542, the end portion of the bolt portion 542b is fitted to a recess formed in the base 542a so as to couple the bolt portion 542b and the base 542a. Thus, an aluminum/copper interface 515A is formed in the positive electrode external terminal 542.

In the fifth embodiment, the sacrificial anticorrosion member 530A is arranged between the bus bar 410c and the base 542a such that it is in contact with both the circumferential face of the bolt portion 542b of the positive electrode external terminal 542 and a flat face 542s of the base 542a around the bolt portion 542b. It should be noted that, in the fifth embodiment, the sacrificial anticorrosion member 530A is preferably configured as a magnesium foil. With such an arrangement, the sacrificial anticorrosion member 530A can be easily mounted by means of an adhesive agent.

By attaching a nut 542c to the bolt portion 542b of the positive electrode external terminal 542 of a given cell 500A1, and by attaching a nut 551c to a bolt portion 551b of a negative electrode external terminal 551 of a different cell 500A2, the cells 500A1 and 500A2 are connected in series. Multiple cells 500A are electrically connected so as to form an assembled battery. It should be noted that the nuts 542c and 551c are each formed of a copper material.

With the fifth embodiment described above, the following effects and advantages are provided.

With the cell 500A, the sacrificial anticorrosion member 530A is provided to the positive electrode external terminal 542 in which the interface 515A between the aluminum and the copper is formed in a current path of charge/discharge current by coupling the base 542a formed of the aluminum material and the bolt portion 542b formed of the copper. The sacrificial anticorrosion member 530A is arranged such that it is in contact with both the base 542a formed of the aluminum and the bolt portion 542b formed of the copper. The sacrificial anticorrosion member 530A is formed of a magnesium material having an ionization tendency that is greater than that of aluminum. With such an arrangement, first-stage corrosion readily occurs in the sacrificial anticorrosion member 530A. This suppresses the occurrence of corrosion in the aluminum member. As a result, such an arrangement is capable of preventing an increase in the contact resistance due to corrosion that occurs in the interface 515A, thereby preventing a reduction in the output of the battery over a long period of time.

It should be noted that, with the fifth embodiment, the mounting position of the sacrificial anticorrosion member 530A may be determined as appropriate so as to provide a sacrificial anticorrosion effect. The present invention is not restricted to such an arrangement in which the sacrificial anticorrosion member 530A is arranged such that it is in contact with both the base 542a and the bolt portion 542b. For example, the sacrificial anticorrosion member 530A may be arranged such that it is in contact with only the outer circumferential side face of the base 542a.

### Modification of Fifth Embodiment

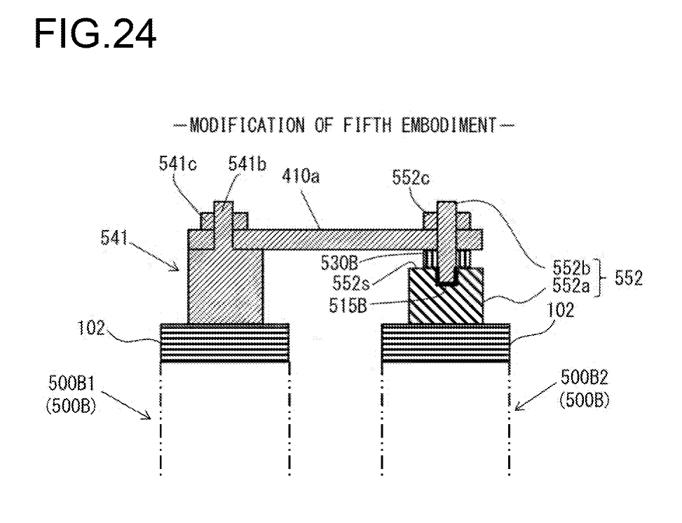

Referring to FIG. 24, description will be made regarding an assembled battery and a cell according to a modification of the fifth embodiment. It should be noted that the same or the corresponding portions as those in the modification of the fourth embodiment are denoted by the same reference numerals, and description will be mainly made regarding the points of difference. FIG. 24 is a diagram showing a sacrificial anticorrosion member 530B provided to a negative electrode external terminal 552 of a cell 500B that is a component of an assembled battery according to a modification of the fifth embodiment.

Description has been made in the modification of the fourth embodiment regarding an arrangement in which the negative electrode external terminal 451 is configured including the bolt portion 451b and the base 451a monolithically formed of the same material (see FIG. 22). In contrast, in the modification of the fifth embodiment, the negative electrode external terminal 552 comprises separate components, i.e., a bolt portion 552b formed of an aluminum material and a base 552a formed of a copper material. With such a negative electrode external terminal 552, the end portion of the bolt portion 552b is fitted to a recess formed in the base 552a so as to couple the bolt portion 552b and the base 552a. Thus, an aluminum/copper interface 515B is formed in the negative electrode external terminal 552.

In the modification of the fifth embodiment, the sacrificial anticorrosion member 530B is arranged between the bus bar 410a and the base 552a such that it is in contact with both the circumferential face of the bolt portion 552b of the negative electrode external terminal 552 and a flat face 552s of the base 552a around the bolt portion 552b. It should be noted that, in the modification of the fifth embodiment, the sacrificial anticorrosion member 530A is preferably configured as a magnesium foil. With such an arrangement, the sacrificial anticorrosion member 530B can be easily mounted by means of an adhesive agent.

By attaching a nut 541c to the bolt portion 541b of the positive electrode external terminal 541 of a given cell 500B1, and by attaching a nut 552c to the bolt portion 552b of the negative electrode external terminal 552 of a different cell 500B2, the cells 500B1 and 500B2 are connected in series. Multiple cells 500B are electrically connected so as to form an assembled battery. It should be noted that the nuts 541c and 552c are each formed of an aluminum material.

With the modification of the fifth embodiment described above, the following effects and advantages are provided.

With the cell 500B, the sacrificial anticorrosion member 530B is provided to the negative electrode external terminal 552 in which the interface 515B between the aluminum and the copper is formed in a current path of charge/discharge current by coupling the bolt portion 552b formed of the aluminum and the base 552a formed of the copper. The sacrificial anticorrosion member 530B is arranged such that it is in contact with both the bolt portion 552b formed of the aluminum and the base 552a formed of the copper. The sacrificial anticorrosion member 530B is formed of a magnesium material having an ionization tendency that is greater than that of aluminum. With such an arrangement, first-stage corrosion readily occurs in the sacrificial anticorrosion member 530B. This suppresses the occurrence of corrosion in the aluminum member. As a result, such an arrangement is capable of preventing an increase in the contact resistance due to corrosion that occurs in the interface 515B, thereby preventing a reduction in the output of the battery over a long period of time.

It should be noted that, with the modification of the fifth embodiment, the mounting position of the sacrificial anticorrosion member 530B may be determined as appropriate so as to provide a sacrificial anticorrosion effect. This modification is not restricted to such an arrangement in which the sacrificial anticorrosion member 530B is arranged such that it is in contact with both the base 552a and the bolt portion 552b. For example, the sacrificial anticorrosion member 530B may be arranged such that it is in contact with only the outer circumferential side face of the base 542a.

It should be noted the following modifications are also within the technical scope of the present invention. Also, one or multiple modifications may be combined with the aforementioned embodiment.

### [Modifications]

(1) Description has been made in the aforementioned embodiments regarding an arrangement in which a magnesium foil or a magnesium plate is employed as a sacrificial anticorrosion member, and the sacrificial anticorrosion member is configured as a sacrificial anticorrosion layer arranged such that it is in contact with the bus bar 110. However, the present invention is not restricted to such an arrangement. Such a sacrificial anticorrosion member may be formed by casting such that the bus bar 110 contains a magnesium material so as to form a sacrificial anticorrosion layer. Also, such a sacrificial anticorrosion layer may be formed by coating the bus bar 110 with a paint containing magnesium powder. Also, such a sacrificial anticorrosion layer may be formed by magnesium plating.

(2) Description has been made in the aforementioned embodiments regarding an arrangement in which the battery container is configured in a rectangular or prismatic shape. However, the present invention is not restricted to such an arrangement. Also, the present invention is applicable to a cell including a flat battery container having an elliptical cross-sectional shape or a cylindrical battery container and an assembled battery including a plurality of such cells.

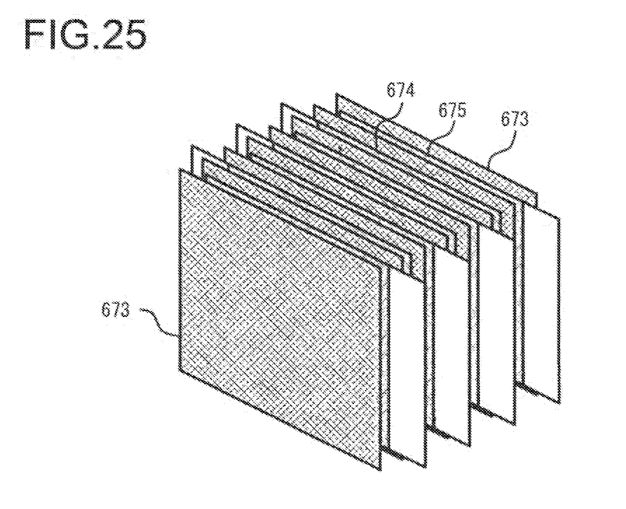

(3) Description has been made, as an example of an electric power generator component, regarding the wound electrode group 170 obtained by winding the positive electrode 174 and the negative electrode 175, each having a large length, together with a separator. Also, as shown in FIG. 25, the present invention is applicable to a laminated electrode set configured by laminating rectangular positive electrodes 674 and negative electrodes 675 via separators 673.

(4) The present invention is not restricted to such an arrangement in which the nut 441c, 541c, or 552c is formed of an aluminum material. Also, the present invention is not restricted to such an arrangement in which the nut 451c, 542c, or 551c is formed of a copper material. Such a nut may preferably be formed of a desired material having an ionization tendency that is smaller than that of aluminum. For example, such a nut may be formed of various kinds of materials, examples of which include stainless steel, carbon steel, and so forth.

(5) Description has been made in the aforementioned embodiments regarding the assembled battery embedded in an electric storage device mounted on a hybrid electric vehicle or an electric vehicle that uses electric power alone. However, the present invention is not restricted to such an arrangement. Also, the present invention is applicable to an assembled battery that can be employed in an electric storage device for other kinds of electric vehicles such as hybrid trains and other rolling stock, passenger vehicles such as buses, freight vehicles such as trucks, industrial vehicles such as battery-powered forklift trucks, etc. Also, the present invention is not restricted to an assembled battery employed in a vehicle. Also, the present invention is applicable to an assembled battery fitted in an uninterruptible power supply device employed in a computer system or a server system, and an assembled battery fitted in an electric storage device that is a component of a power supply device employed in a privately-owned electrical power facility.

Description has been made above regarding various kinds of embodiments and modifications. However, the present invention is not restricted to the contents of such embodiments and modifications. Also, other embodiments conceivable in the technical scope of the present invention are also encompassed by the present invention.

1. A cell, comprising:
a connection member that is formed by combining a first metal material and a second metal material and that includes an interface between the first metal material and the second metal material formed in a current path of charge/discharge current; and
a sacrificial anticorrosion layer that is provided to the connection member and arranged to be in contact with both the first metal material and the second metal material, wherein:
the first metal material is a pure aluminum or an aluminum alloy;
the second metal material is a pure copper or a copper alloy; and
the sacrificial anticorrosion layer is formed of a material having an ionization tendency greater than that of the first metal material and is arranged so as to cover the interface.

2. The cell according to claim 1, wherein:
the connection member is a positive electrode external terminal;
the positive electrode external terminal comprises a positive electrode connection portion to which an electro-conductive member is to be connected so as to electrically connect the cell with another cell; and
the positive electrode connection portion is formed of the second metal material.

3. The cell according to claim 1, wherein:
the connection member is a negative electrode external terminal;
the negative electrode external terminal comprises a negative electrode connection portion to which an electro-conductive member is to be connected so as to electrically connect the cell with another; and
the negative electrode connection portion is formed of the first metal material.

4. The cell according to claim 2, wherein:
the positive electrode external terminal is formed of a composite member comprising the first metal material and the second metal material.

5. The cell according to claim 3, wherein:
the negative electrode external terminal is formed of a composite member comprising the first metal material and the second metal material.

6. The cell according to claim 2, wherein:
the positive electrode connection portion is a bolt.

7. The cell according to claim 3, wherein:
the negative electrode connection portion is a bolt.

8. An assembled battery, comprising:
a plurality of cells, each sell corresponding to the cell according to claim 1, wherein:
the cells are electrically connected with each other.

9. An assembled battery comprising a plurality of cells which are electrically connected with each other, the assembled battery further comprising:
a connection member that is formed by coupling a first metal material and a second metal material and that includes an interface between the first metal material and the second metal material; and
a sacrificial anticorrosion layer that is provided to the connection member arranged to be in contact with both the first metal material and the second metal material, wherein:
the first metal material is a pure aluminum or an aluminum alloy;
the second metal material is a pure copper or a copper alloy; and
the sacrificial anticorrosion layer is formed of a material having an ionization tendency greater than that of the first metal material and is arranged so as to cover the interface.

10. The assembled battery according to claim 9, wherein:
the connection member is an electro-conductive member that electrically connects the cells with each other.

11. The assembled battery according to claim 9, wherein:
the cells are electrically connected via an electro-conductive member formed of the second metal material; and
the connection member is configured by combining the electro-conductive member and a positive electrode external terminal formed of the first metal material.

12. The assembled battery according to claim 9, wherein:
the cells are electrically connected via an electro-conductive member formed of the first metal material; and
the connection member is configured by combining the electro-conductive member and a negative electrode external terminal formed of the second metal material.
